(19) United States
(12) Patent Application Publication
(10) Pub. No.: US 2026/0106970 A1
(43) Pub. Date: Apr. 16, 2026

(54) DECODING METHOD, ENCODING METHOD, DECODER AND ENCODER

(71) Applicant: GUANGDONG OPPO MOBILE TELECOMMUNICATIONS CORP., LTD., Dongguan (CN)

(72) Inventor: Lai ZHANG, Dongguan (CN)

(21) Appl. No.: 19/422,083

(22) Filed: Dec. 16, 2025

Related U.S. Application Data
(63) Continuation of application No. PCT/CN2023/105582, filed on Jul. 3, 2023.

(51) Int. Cl. H04N 19/105; H04N 19/137; H04N 19/159; H04N 19/176

(52) U.S. Cl. CPC H04N 19/105; H04N 19/137; H04N 19/159; H04N 19/176

(57) ABSTRACT

A decoding method, an encoding method, a decoder and an encoder are provided. The decoding method includes that: based on a first prediction mode different from an intra block copy (IBC) mode, block vector information used for a current block is determined; first historical block vector information is determined based on the block vector information used for the current block; and a first historical block vector information list is updated based on the first historical block vector information, herein, the first historical block vector information list is used for determining a candidate block vector information list used for an IBC block, and the IBC block is a block decoded by using the IBC mode after the current block.

### CROSS-REFERENCE TO RELATED APPLICATION

This is a continuation application of International Patent Application No. PCT/CN2023/105582, filed on Jul. 3, 2023, the contents of which are hereby incorporated by reference in its entirety.

### BACKGROUND

Digital video compression technology mainly lies in compressing large volumes of digital video data to facilitate transmission and storage.

With the surge in Internet video and people's higher and higher requirements for video definition, although existing digital video compression standards can reduce the volume of video data, better digital video compression technologies still need to be pursued to reduce the bandwidth and traffic pressure of digital video transmission.

### SUMMARY

The disclosure relates to the technical field of encoding and decoding, and more particularly, to a decoding method, an encoding method, a decoder, and an encoder.

The disclosure provides a decoding method, an encoding method, a decoder and an encoder, which can improve decoding performance for an Intra Block Copy (IBC) block and decoding performance of a decoder.

In a first aspect, the disclosure provides a decoding method, which includes the following operations.

Block vector information used for a current block is determined based on a first prediction mode different from an intra block copy (IBC) mode.

First historical block vector information is determined based on the block vector information used for the current block.

A first historical block vector information list is updated based on the first historical block vector information.

The first historical block vector information list is used for determining a candidate block vector information list used for IBC blocks, and the IBC blocks are blocks decoded by using the IBC mode after the current block.

In a second aspect, the disclosure provides an encoding method, which includes the following operations.

Block vector information used for a current block is determined based on a first prediction mode different from an intra block copy (IBC) mode.

First historical block vector information is determined based on the block vector information used for the current block.

A first historical block vector information list is updated based on the first historical block vector information.

The first historical block vector information list is used for determining a candidate block vector information list used for IBC blocks, and the IBC blocks are blocks encoded by using the IBC mode after the current block.

In a third aspect, the disclosure provides a non-transitory computer-readable storage medium having a computer program and a bitstream stored thereon. The computer program that, when executed on a computer, enables the computer to perform the encoding method to generate the bitstream. The encoding method includes the following operations.

Block vector information used for a current block is determined based on a first prediction mode different from an intra block copy (IBC) mode.

First historical block vector information is determined based on the block vector information used for the current block.

A first historical block vector information list is updated based on the first historical block vector information.

The first historical block vector information list is used for determining a candidate block vector information list used for IBC blocks, and the IBC blocks are blocks encoded by using the IBC mode after the current block.

### BRIEF DESCRIPTION OF THE DRAWINGS

FIG. 1 is a schematic block diagram of a video encoding and decoding system according to the disclosure.

FIG. 2 is a schematic block diagram of a video encoder according to the disclosure.

FIG. 3 is a schematic structural diagram of a relationship between a coding tree unit and a coding unit according to the disclosure.

FIG. 4 is a schematic block diagram of a video decoder according to the disclosure.

FIG. 5 is a schematic diagram of a principle of an intra template matching prediction (IntraTMP) mode according to the disclosure.

FIG. 6 is schematic diagram of an example of a principle of a template matching process used in the IntraTMP mode according to the disclosure.

FIG. 7 is schematic diagram of an example of an IntraTMP adaptation technique for camera-captured content according to the disclosure.

FIG. 8 is schematic diagram of an example of a principle of constructing a candidate block list according to the disclosure.

FIG. 9 is schematic diagram of an example of a principle of an IntraTMP fusion prediction technique according to the disclosure.

FIG. 10 is schematic diagram of an example of a filtering principle of a filter according to the disclosure.

FIG. 11 is schematic diagram of an example of a principle of determining a filter coefficient according to the disclosure.

FIG. 12 is schematic diagram of an example of region partitioning of a current block according to the disclosure.

FIG. 13 is a schematic flowchart of a decoding method according to the disclosure.

FIG. 14 is a schematic flowchart of an encoding method according to the disclosure.

FIG. 15 is a schematic block diagram of a decoder according to the disclosure.

FIG. 16 is a schematic block diagram of an encoder according to the disclosure.

FIG. 17 is a schematic structural diagram of an electronic device according to the disclosure.

### DETAILED DESCRIPTION

The solutions of the disclosure may be applied to the technical field of digital compression.

Digital video compression technology mainly lies in compressing large volumes of digital video data to facilitate transmission and storage.

The solutions of the disclosure may be applied to the technical field of digital video coding.

The technical field of digital video coding includes, but is not limited to, at least one of following: a picture encoding and decoding field, a video encoding and decoding field, a hardware video encoding and decoding field, a dedicated circuit video encoding and decoding field, or a real-time video encoding and decoding field. Further, the solutions of the disclosure may be integrated into the following standards: an Audio Video coding Standard (AVS), a 2^{nd} generation AVS standard (AVS2), or a 3^{rd} generation AVS standard (AVS3). Examples include, but are not limited to, an H.264/Audio Video coding (AVC) standard, an H.265/High Efficiency Video Coding (HEVC) standard, and an H.266/Versatile Video Coding (VVC) standard. In addition, the solutions of the disclosure may be used for lossy compression of pictures or for lossless compression of pictures. The lossless compression may be visually lossless compression or mathematically lossless compression.

A block-based hybrid coding framework may be used in a video encoding and decoding standard.

The hybrid coding framework includes modules such as prediction, transform, quantization, entropy coding, and in-loop filtering. The prediction module includes intra prediction and/or inter prediction module. Because of strong correlation between neighbouring samples in a picture of video, intra prediction is used in a video encoding and decoding technology to eliminate spatial redundancy between neighbouring samples. In process of intra prediction, the information of the same picture is referred to, to predict sample information in a current block partitioned. Because of strong similarity between neighbouring pictures in video, inter prediction is used in a video encoding and decoding technology to eliminate temporal redundancy between neighbouring pictures, thereby improving coding efficiency. Inter prediction includes motion estimation and motion compensation. In process of inter prediction, picture information of different pictures may be referred to, and motion estimation may be used to search for motion vector information that best matches the current block partitioned. In process of transform, a prediction picture block is transformed into a frequency domain, to redistribute energy. Combined with quantization, information that is insensitive to a human eye can be removed to eliminate visual redundancy. By entropy coding, character redundancy can be eliminated according to a current context model and probability information of a binary bitstream.

The basic procedure of a video encoder is as follows.

The encoder firstly partitions a picture into blocks, and then performs prediction for a current block in the current picture to obtain a prediction block for the current block. Next, The encoder subtracts the prediction block from an original block of the current block to obtain a residual block, performs transform and quantization on the residual block to obtain a quantization coefficient matrix, and then performs entropy encoding on the quantization coefficient matrix to obtain an output bitstream.

The basic procedure of a video decoder is as follows.

On the one hand, the decoder performs prediction for a current block to obtain a prediction block for the current block; on the other hand, the decoder parses a bitstream to obtain a quantization coefficient matrix, and performs inverse quantization and inverse transform on the quantization coefficient matrix to obtain a residual block, and then adds the prediction block to the residual block are to obtain a reconstructed block. Reconstructed blocks constitute a reconstructed picture, and in-loop filtering is performed on the reconstructed picture in a picture-wise or block-wise manner to obtain a decoded picture.

It should be noted that the current block may be a current coding unit (CU), a current prediction unit (PU), or the like.

In addition, the encoder also needs to perform operations similar to those of the decoder to obtain the decoded picture. The decoded picture may be provided as a reference picture of inter prediction for subsequent pictures. Block partitioning information, mode information (such as prediction, transform, quantization, entropy encoding, and in-loop filtering) or parameter information that are determined by the encoder are signalled written into the bitstream if necessary. The decoder determines, by parsing and by analysis according to existing information, the same block partitioning information, the mode information (such as prediction, transform, quantization, entropy encoding, in-loop filtering) or the parameter information as those determined by the encoder, so as to ensure that the decoded picture obtained by the encoder is the same as the decoded picture obtained by the decoder. The decoded picture obtained by the encoder is usually referred to as a reconstructed picture. The encoder/decoder may partition the current block into prediction units during prediction, and may partition the current block into transform units during transform, and the partitioning of the prediction units may be different from the partitioning of the transform units. The above is a basic procedure of a video encoder and a video decoder under a block-based hybrid coding framework, and some modules or steps in the framework or procedure may be optimized with the development of technologies, which is not specifically limited in the disclosure.

It should be noted that, the terms used in the embodiments of the disclosure are intended for explaining specific embodiments of the disclosure only, rather than limiting the disclosure.

For example, the term “and/or” herein merely describes a relationship between associated objects, representing that three relationships may exist. For example, A and/or B may represent three cases: existence of A alone, existence of both A and B, and existence of B alone. The term “at least one” merely describes a combination relationship of listed objects, and represents that one or more items may be exist. For example, at least one of: A, B, and C may represent the following combinations: A alone, B alone, C alone, existence of A and B, existence of A and C, existence of B and C, and existence of A, B and C. The term “multiple” refers to two or more. The character “/” generally indicates that the preceding and following associated objects are in an “or” relationship.

For another example, the term “corresponding” may represent a direct correspondence or indirect correspondence between two objects, or may represent an association relationship between the two objects, or may represent a relationship that one object indicates or is indicated by another object or a relationship that one object configures or is configured by another object. The term “indication” may be direct indication or indirect indication, or may refer to that there is an association relationship. For example, “A indicates B” may refer to that A directly indicates B, such as B being acquired through A. “A indicates B” may also refer to that A indirectly indicates B, for example, A indicates C and B may be acquired through C. “A indicates B” may also refer to that there is an association relationship between A and B. The term “predefined” or “preconfigured” may refer to the pre-storage of a corresponding code, table, or other relevant information used for indication in a device (e.g., including an encoder or decoder), or may refer to being agreed by a protocol. The term “protocol” may refer to any standard protocol in the field of coding and decoding, which is not limited in the disclosure. The term “when . . . ” may be interpreted as “if”, “in case of”, “upon”, or “in response to” or the like. Similarly, depending on the context, the phrase “if it is determined” or “if it is detected (a stated condition or event)” may be interpreted as “when it is determined” or “in response to determining” or “when it is detected (a stated condition or event)” or “in response to detecting (a stated condition or event)” or the like. The terms “first”, “second”, “third”, “fourth”, “A-th”, “B-th” or the like are used to distinguish different objects, rather than describing a specific order. The terms “include” and “have” as well as any variations thereof are intended to cover non-exclusive inclusions.

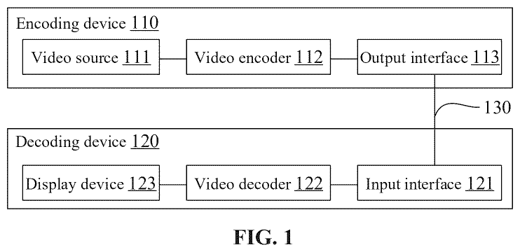

For better understanding, a video encoding and decoding system involved in embodiments of the disclosure is described in conjunction with FIG. 1 at first.

FIG. 1 is a schematic block diagram of a video encoding and decoding system involved in the embodiments of the disclosure.

As illustrated in FIG. 1, the video encoding and decoding system 100 includes an encoding device 110 and a decoding device 120.

The encoding device 110 is configured to encode (which may be understood as “compress”) video data to generate a bitstream, and transmit the bitstream to the decoding device 120. The decoding device 120 decodes the bitstream generated by the encoding device 110 to obtain decoded video data.

The encoding device 110 may be understood as a device having a video encoding function, and the decoding device 120 may be understood as a device having a video decoding function. That is, in the embodiments of the disclosure, the encoding device 110 and the decoding device 120 include a broader range of devices including, for example, a smartphone, a desktop computer, a mobile computing device, a notebook (e.g., a laptop) computer, a tablet computer, a set-top box, a television, a camera, a display device, a digital media player, a video game console, a vehicle-mounted computer, and the like.

The encoding device 110 may transmit the encoded video data (e.g., a bitstream) to the decoding device 120 via the channel 130.

The channel 130 may include one or more media and/or devices capable of transmitting encoded video data from the encoding device 110 to the decoding device 120.

The channel 130 may include one or more communication media that enable the encoding device 110 to transmit the encoded video data directly to the decoding device 120 in real time. The encoding device 110 may modulate the encoded video data according to a communication standard, and transmit the modulated video data to the decoding device 120. The communication media includes a wireless communication medium, such as a radio frequency spectrum. The communication media may also include a wired communication medium, such as one or more physical transmission lines.

The channel 130 may include a storage medium that may store video data encoded by the encoding device 110. The storage medium includes a variety of locally accessible data storage media, such as an optical disk, a digital video disk (DVD), and a flash memory. In this example, the decoding device 120 may acquire the encoded video data from the storage medium.

The channel 130 may include a storage server that may store video data encoded by the encoding device 110. In this example, the decoding device 120 may download the stored encoded video data from the storage server. Optionally, the storage server may store the encoded video data and may transmit the encoded video data to the decoding device 120, such as a web server (e.g., for a website), or a file transfer protocol (FTP) server.

The encoding device 110 includes a video encoder 112 and an output interface 113.

The output interface 113 may include a modulator/demodulator (modem) and/or a transmitter. The video encoder 112 directly transmits the encoded video data to the decoding device 120 via the output interface 113. The encoded video data may also be stored on a storage medium or a storage server for subsequent reading by the decoding device 120.

The encoding device 110 may further include a video source 111 in addition to the video encoder 112 and the output interface 113.

The video source 111 may include at least one of a video acquisition device (e.g., a video camera), a video archive, a video input interface and a computer graphics system. The video input interface is used for receiving video data from a video content provider, and the computer graphics system is used for generating video data. The video encoder 112 encodes video data from the video source 111 to generate a bitstream. The video data may include one or more pictures or sequences of pictures. A bitstream includes the encoded information of pictures or sequences of pictures. The encoded information may include encoded picture data and associated data. The associated data may include a sequence parameter set (SPS), a picture parameter set (PPS), and other syntactic structures. The SPS may include parameters applied to one or more sequences. The PPS may include parameters applied to one or more pictures. A syntactic structure refers to a set of zero or multiple syntactic elements arranged in a specified order in the bitstream.

The decoding device 120 includes an input interface 121 and a video decoder 122. The input interface 121 may include a receiver and/or a modem.

The decoding device 120 may further include a display device 123 in addition to the input interface 121 and the video decoder 122.

The input interface 121 may receive the encoded video data through the channel 130. The video decoder 122 is used for decoding the encoded video data to obtain the decoded video data, and transmits the decoded video data to the display device 123. The display device 123 displays the decoded video data. The display device 123 may be integrated with or external to the decoding device 120. The display device 123 may include a variety of display devices, such as a liquid crystal display (LCD), a plasma display, an organic light emitting diode (OLED) display, or other types of display devices.

It should be understood that FIG. 1 merely illustrates an example of the disclosure, and should not be construed as a limitation of the disclosure. That is, the technical solution of the embodiments of the disclosure is not limited to the system framework illustrated in FIG. 1, and for example, the technology of the disclosure may also be applied in unilateral video encoding or unilateral video decoding.

The video coding framework involved in the embodiments of the disclosure is described below.

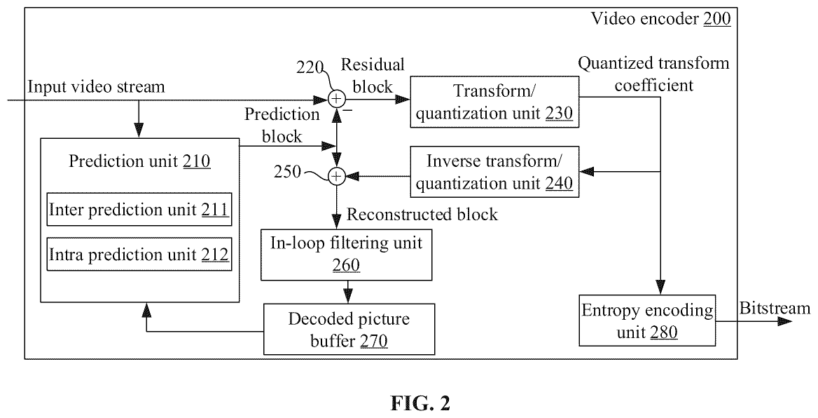

FIG. 2 is a schematic block diagram of a video encoder 200 according to embodiments of the disclosure.

It should be understood that the video encoder 200 may be applied to picture data in a luma-chroma (YCbCr, YUV) format. For example, the YUV ratio may be 4:2:0, 4:2:2, or 4:4:4. Y represents luma. Cb (U) represents blue chroma, Cr (V) represents red chroma. U and V represent chroma used to describe colour and saturation. For example, in the colour format, 4:2:0 indicates that there are 4 luma components and 2 chroma components (YYYYCbCr) per 4 pixels; 4:2:2 indicates that there are 4 luma components and 4 chroma components (YYYYCbCrCbCr) per 4 pixels; and 4:4:4 indicates full-pixel display (YYYYCbCrCbCrCbCrCbCr). Of course, the video encoder 200 may also be applied to picture data in a Red-Green-Blue (RGB) format, which is not specifically limited in the disclosure.

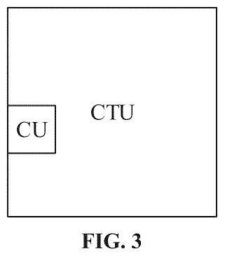

After reading a video stream, the video encoder 200 may partition each picture in the video stream into multiple coding tree units (CTUs). In some examples, the CTU may be referred to as a “tree block”, a “Largest Coding unit” (LCU), or a “coding tree block” (CTB). Each CTU may be associated with a sample block having a same size within the picture. Each sample may correspond to one luma (or luminance) sample and two chroma (or chrominance) samples. Thus, each CTU may be associated with one luma sample block and two chroma sample blocks. A CTU may have a size of, for example, 128×128, 64×64, or 32×32. FIG. 3 is a schematic structural diagram of a relationship between a coding tree unit (CTU) and a coding unit (CU) according to the disclosure. As illustrated in FIG. 3, a CTU may be further partitioned into several coding units (CUs) for encoding, and a CU may be a rectangular block or a square block. A CU may be further partitioned into a prediction Unit (PU) and a transform unit (TU), thereby enabling encoding, prediction, and separable transform for processing more flexible. In one example, a CTU is partitioned into CUs in a tree (e.g., a quadtree) form, and a CU is partitioned into a TU and a PU in a tree (e.g., a quadtree) form.

The video encoder and the video decoder can support various PU sizes.

Assuming that the size of a particular CU is 2N×2N, the video encoder and the video decoder may support PU sizes of 2N×2N or N×N for intra prediction, and support symmetric PUs of 2N×2N, 2N×N, N×2N, N×N, or similar sizes for inter prediction. The video encoder and the video decoder may also support asymmetric PUs of 2N×nU, 2N×nD, nL×2N, and nR×2N for inter prediction.

As illustrated in FIG. 2, the video encoder 200 may include a prediction unit 210, a residual unit 220, a transform/quantization unit 230, an inverse transform/quantization unit 240, a reconstruction unit 250, an in-loop filtering unit 260, a decoded picture buffer 270, and an entropy encoding unit 280. It should be noted that the video encoder 200 may include more, fewer, or different functional components. In the disclosure, the current block may be referred to as a current coding unit (CU) or a current prediction unit (PU). A prediction block may also be referred to as a prediction picture block or a picture prediction block, and a reconstructed picture block may also be referred to as a reconstructed block or a picture-reconstruction picture block.

The prediction unit 210 includes an inter prediction unit 211 and an intra prediction unit 212. Because of strong correlation between neighbouring samples in a picture of video, intra prediction is used in a video encoding and decoding technology to eliminate spatial redundancy between neighbouring samples. Because of strong similarity between neighbouring pictures in video, inter prediction is used to eliminate temporal redundancy between neighbouring pictures, thereby improving coding efficiency.

The inter prediction unit 211 may be used for inter prediction, which may include motion estimation and motion compensation. Picture information of different pictures may be referred to. In inter prediction, motion information is used to find a reference block from a reference picture, and generates a prediction block according to the reference block, so as to eliminate temporal redundancy. The reference picture may be a P frame and/or a B frame. The P frame refers to a forward prediction picture, and the B frame refers to a bi-directional picture. Inter prediction finds a reference block by using motion information, and generates a prediction block based on the reference block. The motion information includes a picture list to which the reference picture belongs, a picture index, and a motion vector. The motion vector may be of an integer sample or a fractional sample. If the motion vector is of a fractional sample, interpolation filtering is required to be performed in a reference picture to generate a required fractional sample block. The reference block is a block of an integer sample or a fractional sample block identified according to the motion vector. In some technologies, the reference block is directly used as a prediction block, and in some technologies, the reference block is further processed to generate the prediction block. The event that the reference block is further processed to generate the prediction block may also be understood as taking the reference block as a prediction block and then processing the prediction block to generate a new prediction block.

The intra prediction unit 212 predicts sample information in the current coding block only with reference to the information of the same picture, for eliminating spatial redundancy. The reference picture used in intra prediction may be an I frame.

There are multiple prediction modes for intra prediction. An angular prediction mode and a non-angular prediction mode may be used to predict the picture block to-be-encoded, to obtain the prediction block. According to the prediction block and the picture block to-be-encoded, rate distortion information is calculated, an optimal prediction mode of the picture block to-be-encoded is selected and signalled into a bitstream for transmission to the decoding end. The decoding end obtains the prediction mode by parsing, predicts the prediction block of the target coding block, and adds the prediction block to a temporal residual block obtained based on the bitstream, to obtain a reconstructed block.

With the international digital video coding standard H series as an example, the H.264/AVC standard has 8 angular prediction modes and 1 non-angular prediction mode, and the H.265/HEVC is expanded to 33 angular prediction modes and 2 non-angular prediction modes. Intra prediction modes used in the HEVC include a planar mode (Planar), a direct current (DC) mode and 33 angular modes, which are a total of 35 prediction modes. Intra prediction modes used in the VVC include the Planar, the DC, and 65 angular modes, which are a total of 67 prediction modes, including traditional prediction modes and non-traditional prediction modes. The non-traditional prediction modes include a Matrix weighted intra prediction (MIP) mode. The traditional prediction modes include: a planar mode with a mode number 0, a DC mode with a mode number 1, and angular prediction modes of mode numbers 2 to 66. It should be noted that as the number of angular mode increases, the prediction result of the intra prediction will be more precise, thereby better meeting the demands for high-definition and ultra-high-definition digital video development. The intra prediction modes described above are only examples of the disclosure, and should not form limitation to the disclosure.

The residual unit 220 may generate a residual block for the CU based on a sample block of the CU and a prediction block for the PU of the CU. For example, the residual unit 220 may generate a residual block for the CU such that each sample in the residual block has a value equal to a difference between a sample in the sample block of the CU and a corresponding sample in the prediction block for the PU of the CU.

The transform/quantization unit 230 may quantize transform coefficients. The transform/quantization unit 230 may quantize transform coefficients associated with the TU of the CU based on a quantization parameter (QP) value associated with the CU. The video encoder 200 may adjust the degree of quantization applied to the transform coefficients associated with the CU, by adjusting the QP value associated with the CU.

The inverse transform/quantization unit 240 may apply inverse quantization and inverse transform to the quantized transform coefficients respectively, to reconstruct the residual block from the quantized transform coefficients.

The reconstruction unit 250 may add samples of the reconstructed residual block to corresponding samples of one or more prediction blocks generated by the prediction unit 210, so as to generate a reconstructed picture block associated with the TU. By reconstructing the sample block of each TU of the CU in this manner, the video encoder 200 can reconstruct the sample block of the CU.

The in-loop filtering unit 260 is configured to process inversely transformed and inversely quantized samples to compensate for distortion information, and to provide a better reference for subsequently encoding the samples. For example, the in-loop filter unit 260 may perform a deblocking filtering operation to reduce the blocking effect of the sample block associated with the CU. In some embodiments, the in-loop filtering unit 260 includes a DeBlocking Filter (DBF) unit and a sample adaptive offset/adaptive in-loop filtering (SAO/ALF) unit. The DBF unit is used to remove the blocking effect and the SAO/ALF unit is used to remove the ringing artifacts.

The decoded picture buffer 270 may store reconstructed sample blocks.

Here, the inter prediction unit 211 may perform inter prediction on PUs of other pictures by using a reference picture containing the reconstructed sample block in the decoded picture buffer 270. In addition, the intra prediction unit 212 may perform intra prediction on other PUs in a same picture as the CU by using the reconstructed sample block in the decoded picture buffer 270.

The entropy encoding unit 280 may receive the quantized transform coefficients from the transform/quantization unit 230. The entropy encoding unit 280 may perform one or more entropy coding operations on the quantized transform coefficients to generate entropy-coded data.

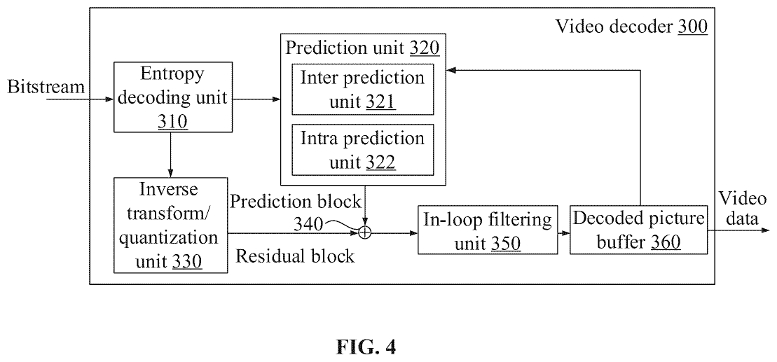

FIG. 4 is a schematic block diagram of a video decoder 200 involved in embodiments of the disclosure.

As illustrated in FIG. 4, the video decoder 300 includes an entropy decoding unit 310, a prediction unit 320, an inverse quantization/transform unit 330, a reconstruction unit 340, an in-loop filtering unit 350, and a decoded picture buffer 360. It should be noted that the video decoder 300 may include more, fewer, or different functional components.

The video decoder 300 may receive a bitstream. The entropy decoding unit 310 may parse the bitstream to extract syntactic elements from the bitstream. As part of parsing the bitstream, the entropy decoding unit 310 may parse entropy encoded syntactic elements in the bitstream. The prediction unit 320, the inverse quantization/transform unit 330, the reconstruction unit 340, and the in-loop filtering unit 350 may decode video data according to the syntactic elements extracted from the bitstream, to generate decoded video data.

The prediction unit 320 includes an intra prediction unit 322 and an inter prediction unit 321.

The intra prediction unit 322 may perform intra prediction to generate a prediction block for a PU. The intra prediction unit 322 may generate, in an intra prediction mode, the prediction block for the PU based on a sample block of a spatially neighbouring PU. The intra prediction unit 322 may also determine the intra prediction mode for the PU according to one or more syntactic elements parsed from the bitstream.

The inter prediction unit 321 may construct a first reference picture list (List 0) and a second reference picture list (List 1) according to the syntactic elements parsed from the bitstream. Additionally, if a PU is encoded by using inter prediction, the entropy decoding unit 310 may parse motion information of the PU. The inter prediction unit 321 may determine one or more reference blocks for the PU according to the motion information of the PU. The inter prediction unit 321 may generate the prediction block for the PU according to the one or more reference blocks for the PU.

The inverse quantization/transform unit 330 may reversely quantize (i.e., de-quantizes) transform coefficients associated with a TU. The inverse quantization/transform unit 330 may determine a degree of quantization by using a QP value associated with a CU of the TU. After inversely quantizing the transform coefficients, the inverse quantization/transform unit 330 may apply one or more inverse transforms to the inversely quantized transform coefficients, in order to generate a residual block associated with the TU.

The reconstruction unit 340 uses a residual block associated with the TU of the CU and a prediction block for the PU of the CU to reconstruct a sample block of the CU. For example, the reconstruction unit 340 may add samples of the residual block to corresponding samples of the prediction block to reconstruct the sample block of the CU, to obtain a reconstructed picture block.

The in-loop filtering unit 350 may perform a deblocking filtering operation to reduce the blocking effect of the sample block associated with the CU.

The video decoder 300 may store a reconstructed picture of the CU in the decoded picture buffer 360. The video decoder 300 may use the reconstructed picture in the decoded picture buffer 360 as a reference picture for subsequent prediction, or may transmit the reconstructed picture to a display device for rendering.

Combined with FIG. 2 and FIG. 4, the basic procedure of video encoding and decoding is as follows.

At the encoding side, a picture is partitioned into picture blocks, and for a current block, the prediction unit 210 predicts a prediction block for the current block (i.e., a block to-be-encoded) by using intra prediction or inter prediction. The residual unit 220 may calculate a residual block based on the prediction block and the original block of the current block (that is, the block to-be-encoded), that is, a difference between the prediction block and the original block. The residual block may also be referred to as residual information. Procedures such as transform and quantization are performed on the residual block through the transform/quantization unit 230, which can remove information that is insensitive to a human eye, to eliminate visual redundancy. Optionally, the residual block before being transformed and quantized by the transform/quantization unit 230 may be referred to as a temporal residual block, and the temporal residual block after being transformed and quantized by the transform/quantization unit 230 may be referred to as a frequency residual block or a frequency-domain residual block. The entropy encoding unit 280 receives quantized transform coefficients output by the transform/quantization unit 230, and may perform entropy encoding on the quantized transform coefficients to output a bitstream. For example, the entropy encoding unit 280 may eliminate character redundancy according to a target context model and probability information of the binary bitstream.

At the decoding side, the entropy decoding unit 310 may parse the bitstream to obtain prediction information, a quantization coefficient matrix, and the like for the current block (i.e., the block to be decoded), and the prediction unit 320 predicts a prediction block for the current block (i.e., the block to be decoded) by using intra prediction or inter prediction based on the prediction information. The inverse quantization/transform unit 330 inversely quantizes and inversely transforms on the quantization coefficient matrix obtained from the bitstream, to obtain a residual block. The reconstruction unit 340 adds the prediction block and the residual block to obtain a reconstructed block. Reconstructed blocks constitute a reconstructed picture, and the in-loop filtering unit 350 performs in-loop filtering on the reconstructed picture in a picture-wise or block-wise manner to obtain a decoded picture. It is worth noting that the encoding end also needs to perform operations similar to those of the decoder to obtain the decoded picture. The decoded picture may also be referred to as a reconstructed picture, and the reconstructed picture may serve as a reference picture for inter prediction of a subsequent picture.

In addition, block partitioning information, and mode information or parameter information (such as prediction, transform, quantization, entropy encoding, and in-loop filtering) that are determined by the encoder are carried in the bitstream when necessary. The decoding end determines, by parsing the bitstream and by performing the analysis according to existing information, the same block partitioning information, the mode information or the parameter information (such as prediction, transform, quantization, entropy encoding, in-loop filtering) as those determined at the encoding end, so as to ensure that the decoded picture obtained by the encoder is the same as the decoded picture obtained by the decoder.

It should be noted that due to the need of parallel processing, a picture may be partitioned into slices or the like, and slices in the same picture may be processed in parallel, that is to say, there is no data dependence between the slices. The term “frame” may be understood as a picture, slices, or the like. In addition, the above is a basic procedure of a video encoder and a video decoder under a block-based encoding and decoding framework, and some modules or steps in the framework or procedure may be optimized with the development of technologies. The disclosure is not limited to the framework or procedure.

In order to facilitate understanding of the technical solutions of the disclosure, the related contents will be described below.

### (1) Intra Template Matching Prediction (IntraTMP) Mode.

The IntraTMP mode is a special luma block intra prediction coding tool, which is mainly used in screen content coding.

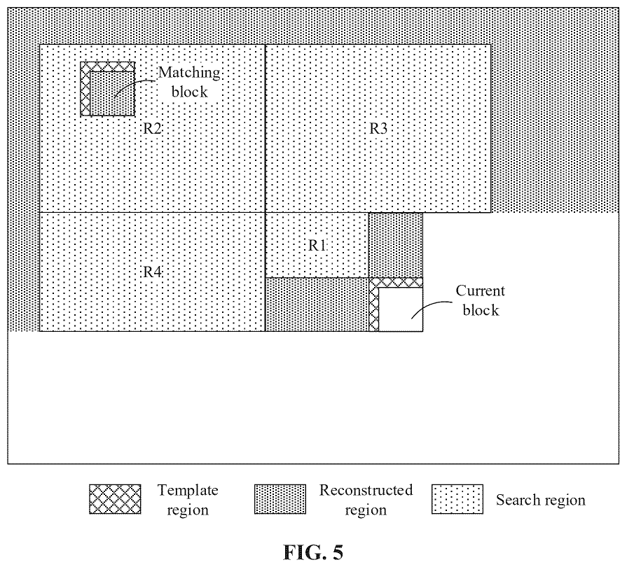

FIG. 5 is a schematic diagram of a principle of an intra template matching prediction (IntraTMP) mode according to the disclosure.

As illustrated in FIG. 5, the IntraTMP mode is mainly implemented through the following procedure.

The encoder (or decoder) selects the reconstructed samples of the L-shaped part neighbouring to the current coding block as a template, to search for a most similar template in a given reconstructed region of the current picture, and takes a reconstructed block corresponding to the most similar template as a matching block serving as a prediction block of the current coding block. For example, R1 to R4 in the figure are search regions available for the IntraTMP mode. For example, a matching block may be searched point by point in a raster scan order in R1 to R4.

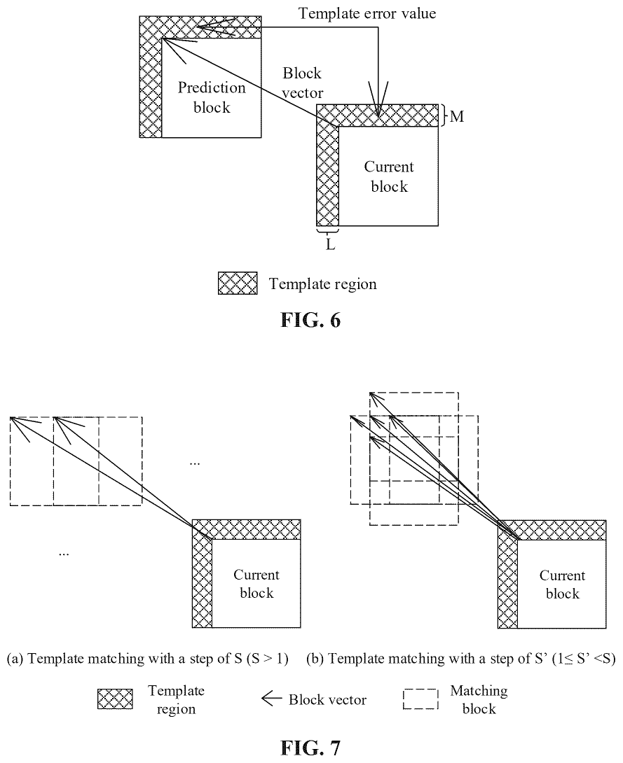

FIG. 6 is schematic diagram of an example of a principle of a template matching process used in the IntraTMP mode according to the disclosure.

As illustrated in FIG. 6, the template of the current block may include L columns of samples on the left side, M rows of samples on the top side, and M rows and L columns of samples on the top-left corner of the current block, where M and L are both positive integers. For example, the values of M and L are both 4. The matching block for the current block may be represented by a block vector pointing from the current block to the matching block, and the similarity between the template of the current block and the template of the matching block is represented by the magnitude of a template error value. The smaller the template error value, the higher the similarity. For example, the template error value can be calculated using the Sum of Absolute Difference (SAD). The smaller the SAD, the more similar the templates are.

The encoder used a flag bit cu_tmp_flag to indicate whether the IntraTMP mode is used for the current coding block. If so, the same template matching process is performed at the decoding end to obtain the same prediction block at the decoding end. For the IntraTMP mode, no additional block vector information is required to be encoded in the bitstream.

It should be understood that the term “block vector” referred to herein may also be referred to as other description having a similar meaning.

### (2) IntraTMP Adaptation Technique for Camera-Captured Content.

FIG. 7 is schematic diagram of an example of an IntraTMP adaptation technique for camera-captured content according to the disclosure.

As illustrated in (a) of FIG. 7, based on the original IntraTMP mode, it is proposed to perform template matching with a step size S (that is, every S points in horizontal and vertical directions, S>1) in the IntraTMP adaptation technique for camera-captured content. For example, in the search region, instead of a point-by-point search for a matching block by using raster scan, search is performed every S points in the search region in the horizontal and vertical directions. For example, the block vector currently for template matching is (X₀, Y₀), then the next block vector for template matching in the horizontal direction should be (X₀+S, Y₀), and the vertical coordinate of the next block vector for template matching in the vertical direction should be Y₀+S. After the template matching is completed, as illustrated in (b) of FIG. 7, the best matching block is refined within a certain range (i.e., template matching is performed with a smaller step size S′). For example, the matched block vector is refined by performing template matching with a smaller step size within the range to optimize the matching result. This technique can effectively reduce the complexity of the IntraTMP mode while maintaining good coding efficiency.

### (3) IntraTMP Multi-Candidate Technique.

In the IntraTMP multi-candidate technique, N candidate matching blocks are obtained in the reference region through the template matching process, or a candidate block list with a length N is constructed. Candidate blocks in the list may be sorted according to the template error values between the candidate blocks and the current block. A candidate block in the list is selected as a final prediction block through an index. For a coding block using the IntraTMP multi-candidate technique, after decoding the IntraTMP flag bit intra_tmp_flag as true, the decoder continues to decode intra_tmp_idx. The syntactic element intra_tmp_idx may represent an index of a selected candidate block.

The process by which the decoder decodes a syntactic element may be as follows:

intra_tmp_flag
If (intra_tmp_flag)
{
intra_tmp_idx
}.

Then, regarding how to construct the candidate block list (intraTmpCandList), an example is as follows:

For each searched block vector (BV), since a template cost for the BV is calculated in the IntraTMP, the template cost is generally the cost of matching a template of the current block and a template of a block which is determined by the current BV and has a same size as the current block. The cost may be a sum of absolute differences (SAD), a sum of absolute transformed differences (SATD), a sum of squared errors (SSE), etc. In IntraTMP, the searched blocks or searched BVs may be sorted in ascending order according to these costs, and the first N candidates are the N candidates of the intraTmpCandList. Alternatively, only the top N candidates with minimum costs are maintained, and candidates ranked after N may be directly discarded, thereby reducing computational overhead.

Generally, blocks corresponding to neighbouring BVs are relatively close to each other, especially if the BVs support fractional sample precision, such as ½, ¼, ⅛, and 1/16 precision. If the sorting is performed only according to the template costs without control, it is easy to concentrate multiple candidates into a very small range. Therefore, some control needs to be done here to avoid candidate BVs in intra TmpCandList from being too much concentrated.

One approach is as follows.

Not every possible BV is searched sequentially during search. For example, a usual search order is from left to right and from top to bottom. Generally, the integer sample BVs may be searched sequentially. If a currently searched BV is (x0, y0), then a next one is (x0+1, y0), on condition that the boundary of the search range is not reached. However, here a sparse search may be performed first. For example, for the integer sample BVs, if a currently searched BV is (x0, y0), then the next one is (x0+4, y0), on condition that the boundary of the search range is not reached. That is, template matching is performed every certain number of samples, which may also be referred to as that template matching is performed every certain step size. The step size here may be a preset value, such as 2, 4, or 8. Of course, the same processing may be performed in the vertical direction. N BVs with minimum costs are identified at first. Then, based on the N BVs with the minimum costs, refinement is performed in a small range based on each BV. If an interval of the above search is 4 samples, the range of refinement here may be set to 4×4, and refined BVs may replace the original BVs and be resorted among the N candidates. In this way, N BV candidates with certain distances can be obtained.

For example, if N is 3, a refinement may be performed in the following manner:

### Step 1:

A first-pass search is performed with a certain step size, for example, a horizontal step size and a vertical step size of K. N optimal matching blocks with a certain spacing (the top N matching blocks with the minimum template error values) are obtained.

### Step 2:

A second-pass search is performed in neighbouring regions of the N matching blocks obtained in Step 1. These neighbouring regions may be set as multiple non-overlapping regions according to the step size in Step 1. M optimal matching blocks are obtained from these regions (which may contain a matching block(s) obtained in Step 1).

If the fractional sample precision is supported, subsequent refinement may be performed to fractional sample BVs. For example, based on the integer sample BVs selected in Step 2, ½-sample search may be performed within a one-sample range in the up, down, left and right directions.

It is worth noting that a candidate list is constructed by both the encoding end and the decoding end, so as to ensure that the candidate list obtained by the encoding end and the candidate list obtained by the decoding end are consistent with each other.

FIG. 8 is schematic diagram of an example of a principle of constructing a candidate block list according to the disclosure.

As illustrated in (a) of FIG. 8, in Step 1, the first-pass search is performed according to the preset step size, and the top-left corners of the searched blocks are as illustrated by gray dots. As illustrated in (b) of FIG. 8, the sorted 3 BVs are identified, and the top-left corners of the corresponding blocks are as illustrated by black dots. Here, the step size in the horizontal direction is 4, and the step size in the vertical direction is 4. In Step 2, the second-pass search may be performed based on the three sorted BVs, with the search range of 4×4. The BV with the minimum cost within each 4×4 range is identified to replace the original BV and participate in the resorting of the intraTmpCandList. Of course, if the BV with the minimum cost is still the original BV, the resorting may not be performed.

Since the intraTmpCandList is sorted, statistically speaking, a candidate ranked higher has a greater probability of being selected. Therefore, variable-length coding or a truncated unary coding may be set for the coding of intra_tmp_idx. For example, the variable-length coding manner is as illustrated in Table 1 below.

TABLE 1

| | |
|---|---|
| intra_tmp_idx | Binary symbol |

| | | |
|---|---|---|
| 0 | 1 | |
| 1 | 0 | 1 |
| 2 | 0 | 0 |
| Bin index | 0 | 1 |

Of course, fixed-length coding or a truncated binary coding may be used if possibilities of candidates are similar.

When N is relatively large, the probabilities of earlier candidates are higher, while subsequent candidates have lower probabilities that gradually converge. Therefore, shorter codewords may be set for high-probability candidates, longer codewords may be set for low-probability candidates, and a same code length may be used for some later candidates. For example, the encoder may perform encoding in the manner as illustrated in Table 2.

TABLE 2

| Intra_tmp_idx | Binary symbol | | | | |
|---|---|---|---|---|---|
| 0 | 1 | 1 | | | |
| 1 | 1 | 0 | 0 | | |
| 2 | 1 | 0 | 1 | | |
| 3-6 | 0 | x | x | x | |
| 7-14 | 0 | x | x | x | x |

As illustrated in Table 2, assuming that N is 15, codewords of a same length are used for indexes 3 to 6, and codewords of a same length are used for indexes 7 to 14. x in the above table may be obtained by using a truncated binary coding.

### (4) IntraTMP Fusion Prediction Technique

Through intra template matching, template error values between reconstructed blocks at different positions and a current coding block may be obtained, and these reconstructed blocks may be represented by block vectors pointing from the current coding block to the reconstructed block. A candidate block vector information list is constructed for recording block vectors with smaller template error values during template matching. Based on conditions such as block vector spacing and template error values, one or more block vectors are selected from the candidate block vector information list, and the reconstructed block(s) to which these block vectors point is/are a matching block(s) for the current coding block. A weight value is determined for each matching block. These matching blocks are weighted and fused according to their weight values to obtain the final prediction block, thereby achieving IntraTMP combined fusion prediction.

The number of matching blocks to be fused may be a fixed value, or may be determined according to the magnitude relationship of template error values of the matching blocks. For example, for available N matching blocks, a threshold is set as Threshold=minSAD<<1 is set, and minSAD is the minimum template error value among the template error values of these matching blocks. Only matching blocks with template error values less than or equal to the threshold are used in the fusion process. In this way, matching blocks for fusion can be determined.

After determining the matching blocks for fusion, the weight of each matching block may be determined by using a preset fixed value, by calculation according to the template error value, and by derivation according to the template.

FIG. 9 is schematic diagram of an example of a principle of an IntraTMP fusion prediction technique according to the disclosure.

As illustrated in FIG. 9, assuming that the number of matching blocks for fusion is 3, that is, the matching blocks for fusion include a matching block 1, a matching block 2, and a matching block 3, and assuming that the weight of the matching block 1 is W1, the weight of the matching block 2 is W2, and the weight of the matching block 3 is W3, the prediction block for the current block may be: W1×matching block 1+W2× matching block 2+W3× matching block 3.

### (5) IntraTMP Filtering Technique

A matching block (which may also be referred to as a reference block) obtained by intra template matching may be directly used as a prediction block of the current block. Further, the prediction block may be filtered to improve the prediction effect. A block-level flag bit may be used to indicate whether the filtering processing is applied to the prediction block for the current block.

There are many forms of filters, and one possible filter form is as follows:

$$predC = c 0 C + c 1 N + c 2 S + c 3 E + c 4 W + c 5 B$$

where this filter performs filtering by using a cross shape formed by a sample to be filtered, and neighbouring samples each on the top, bottom, left and right of the sample to be filtered, respectively.

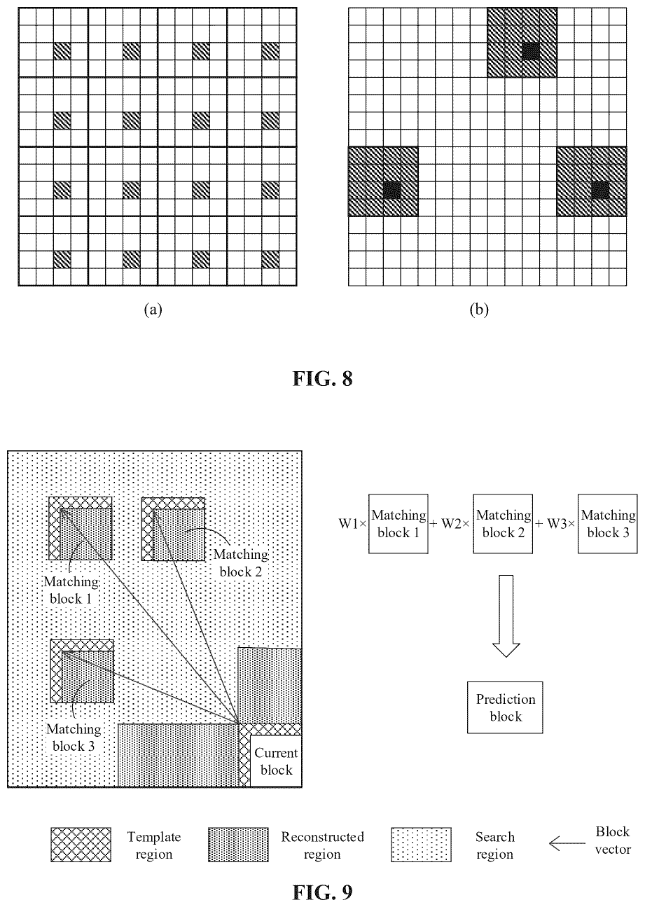

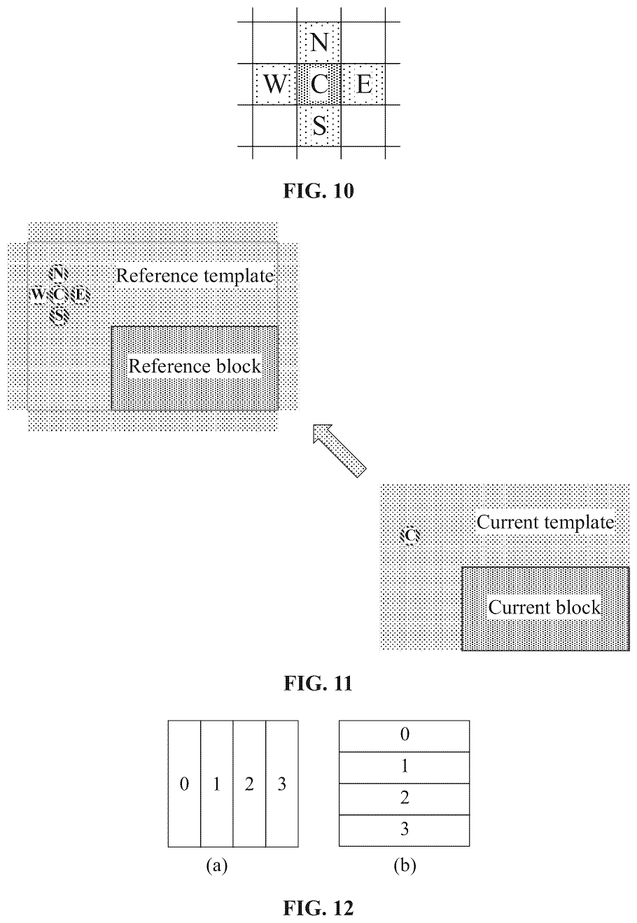

Specifically, as illustrated in FIG. 10, C is a sample to be filtered, N is a sample at the top of C, S is a sample at the bottom of C, W is a sample at the left of C, and E is a sample at the right of C; and B (bias) is a fixed value. For example, B may be the median value of a range of sample values; that is, if a maximum value of the 10-bit sample values is 1023, then B is set to 512. c0 to c5 are filter coefficients.

Furthermore, an approach to determine the filter coefficients is to train the filter coefficients with a template of a reference block and a template of the current block.

FIG. 11 is schematic diagram of an example of a principle of determining a filter coefficient according to the disclosure.

As illustrated in FIG. 11, a template region is a reconstructed region of 4 rows on the top of the current block and 4 columns on the left of the current block. Regarding a reference block, an additional region of rows each at the top, bottom, left and right of the template region respectively is further needed as a reference. It should be noted that, if a part of the additional region is not completely encoded, copy may be performed from the template region.

In addition, an approach to train filter coefficients is to calculate a set of coefficients that minimize the Mean Square Error (MSE) between the filtered reference block template and the current block template.

If IntraTMP filtering is applied to the current block, the prediction block directly obtained from the reference block may be filtered. One approach is to sequentially filter each sample from left to right and top to bottom, and take the filtered values as prediction values.

It is worth noting that in the IntraTMP multi-candidate method, a template is used to select a small number of promising candidates from a large number of possible BVs, and then the encoder selects a candidate to determine the reference block or prediction block for the current block. Due to the correlation between the current block and the template, most unreasonable BVs can be filtered out by using the template; and on the other hand, the encoder can access the original sample values of the current block, and thus can make a more accurate judgment than the decoder. In this way, better compression efficiency can be achieved by cooperation of the encoder and the decoder. In IntraTMP filtering, template(s) may be used to train filter coefficients, refining the original prediction values from intraTMP.

### (6) Template-Derived IntraTMP Fusion Technique

In IntraTMP fusion prediction, multiple reference blocks may be obtained through an intra template matching process, and weighted fusion is performed on these reference blocks. The weight values are typically predefined fixed values or calculated based on reference block template errors. In the template-derived IntraTMP fusion method, a method similar to filter coefficient training approach is used, and the weights used for fusion prediction are obtained by training based on the reference block templates and the current block template. For example, 5 reference blocks are used for the weighted fusion, which may be expressed as follows:

$$pred = {\sum }_{n = 0}^{4} {w}_{n} * {refBlock}_{n} + {w}_{5} * Bias$$

where Wₙ represents the weight of the n-th reference block, refBlockₙ represents the n-th reference block, Bias is a fixed value.

In addition, another method of obtaining the weights is to calculate a set of coefficients that minimize the Mean Square Error (MSE) between the fused reference block template and the current block template.

### (7) Template-Based Intra Mode Derivation (TIMD) Technique

In the TIMD technique, reconstructed samples in an L-shaped part neighbouring to a current coding block are used as a template. Specifically, the encoding end may calculate prediction samples of a template region in different intra prediction modes by traversing a Most Probable Mode (MPM) list, to obtain a template error value of prediction samples and reconstructed samples in each of different intra prediction modes. For example, the template error value may be represented by a Sum of Absolute Transformed Difference (SATD). Hence, the encoding end can select an optimal intra prediction mode according to the template error values. At the decoding end, the intra prediction mode is obtained by using the same derivation manner, thereby reducing the coding bits of mode information.

### (8) Combined Inter and Intra Prediction (CIIP) Mode.

In the CIIP mode, intra prediction and inter prediction are combined, and a prediction block for the current coding block is obtained by weighted combining an intra prediction block and an inter prediction block. In an Enhanced Compression Model (ECM), the CIIP mode is combined with the template-based prediction technique, and different weight values are designed for different regions, which further improves the accuracy of prediction. Specifically, the intra prediction block pred_intra is obtained via the TIMD mode, and the inter prediction block pred_inter is obtained via a template-based Merge mode. The encoding end determines the weight values wIntra and wInter according to the derived intra prediction mode and the position of the sample to be predicted. The final prediction block Pred is calculated as follows:

$$Pred = ( wIntra * Pred\_intra + wInter * Pred\_inter + 4 ) ≫ 3$$

where Pred represents a prediction block for the current block, pred_intra represents an intra prediction block, wIntra represents a weight value of the intra prediction block, pred_inter represents an inter prediction block, and wInter represents a weight value of the inter prediction block.

wIntra and wInter may be determined based on the intra prediction mode intra_dir derived by TIMD. There are 65 intra angular prediction modes (2≤intra_dir<=66) in the ECM. When 2≤intra_dir<34, the current coding block is vertically quartered; and when 34<=intra_dir<=66, the current coding block is horizontally quartered. For example, the weight values wIntra and wInter for each region may be determined with reference to Table 3:

TABLE 3

| Region index | (wIntra, wInter) |
|---|---|
| 0 | (6, 2) |
| 1 | (5, 3) |
| 2 | (3, 5) |
| 3 | (2, 6) |

As illustrated in Table 3, different region indexes correspond to different wIntra values and different wInter values. Specifically, when a region identifier is 0, wIntra is 6 and wInter is 2. When a region identifier is 1, wIntra is 5 and wInter is 3. When a region identifier is 2, wIntra is 3 and wInter is 5. When a region identifier is 3, wIntra is 2 and wInter is 6.

FIG. 12 is schematic diagram of an example of region partitioning of a current block according to the disclosure.

As illustrated in (a) of FIG. 12, when the current coding block is vertically quartered, the region indexes are sequentially 0, 1, 2, and 3 from left to right. As illustrated in (b) of FIG. 12, when the current coding block is horizontally quartered, the region indexes are sequentially 0, 1, 2, and 3 from top to bottom.

It should be noted that when intra_dir is equal to 0 or 1, wIntra and wInter may be determined through other manners. For example, when intra_dir is equal to 0 or 1, no sub-regions are partitioned, and wIntra and wInter are selected from (3, 1), (2, 2), (1, 3) according to the coding types (intra or inter) of the two coding blocks located on the left and the top. For example, if the coding types of these two coding blocks are both intra coding, the encoding end determines (wIntra, wInter) to be (3, 1); if the coding type of one of the two coding blocks is intra coding and the coding type of the another one of two coding blocks is inter coding, the encoding end determines (wIntra, wInter) to be (2, 2); and if the coding types of the two coding blocks are both inter coding, the encoding end determines (wIntra, wInter) to be (3, 1).

### (9) Intra Block Copy (IBC) Mode.

The IBC mode is an intra prediction technique that obtains prediction samples based on block matching. Similar to inter prediction, prediction is achieved through a block vector pointing from a current block to a reference block, the difference is that a reference block for inter prediction comes from an encoded reconstructed picture, while the reference block for IBC comes from a reconstructed part of a current picture. The block vector information needs to be transmitted via a bitstream, which is similar to intra prediction.

The IBC mode may be classified into an IBC advanced motion vector prediction (AMVP) mode and an IBC merge mode.

In the IBC-AMVP mode, a prediction block vector may be obtained based on a constructed candidate block vector information list; a reference block for a current block and a corresponding final block vector may be obtained through processes such as hash search and full search; and the final block vector may be encoded based on the prediction block vector, for example, a residual between the prediction block vector and the final block vector may be encoded, to improve coding efficiency. In the IBC-Merge mode, prediction may be performed based on the constructed candidate block vector information list, a best block vector in the list may be selected as the final block vector through coding processes such as SATD and RDO, and a reconstructed block to which the final block vector points serves as a reference block to complete prediction. The encoder encodes an index of the block vector in the list rather than the block vector itself, thereby improving coding efficiency.

The candidate block vector information list may be composed of coding information such as block vectors of neighbouring coding blocks, historical block vectors, and an average block vector.

### (10) History-Based MV Prediction Technique of IBC

In the history-based MV prediction technique of IBC, a historical block vector information list with a maximum length of N is maintained, to record the block vectors of encoded IBC blocks. When a certain coding block completes encoding by using an IBC mode, the historical block vector information list is updated. If a current block vector is already in the historical block vector information list, this block vector in the list is moved to the end of the list; otherwise, it is firstly determined whether the historical block vector information list is full, and if it is full, a block vector at the foremost of the list is moved out. The current block vector is then added to the end of the historical block vector information list.

The historical block vector information list may be used for constructing a Merge list of IBC.

From the above, it can be seen that in the history-based MV prediction technique of IBC, block vectors of encoded IBC blocks may be stored for constructing a Merge list of subsequently IBC coding blocks, enriching candidate block vectors for IBC, thereby improving coding efficiency. In addition, in the IntraTMP technology, block vectors for prediction may be obtained through intra template matching, without encoding block vectors. That is, the prediction process in the IntraTMP technology is similar to that of the IBC technology which obtains a reference block from a reconstructed part of a current picture based on a block vector. In view of this, the disclosure integrates these two technologies, the block vector of the coding block in Intra TMP may be stored in the historical block vector information list of the IBC, to enrich the candidate block vectors for the IBC, thereby improving the coding efficiency.

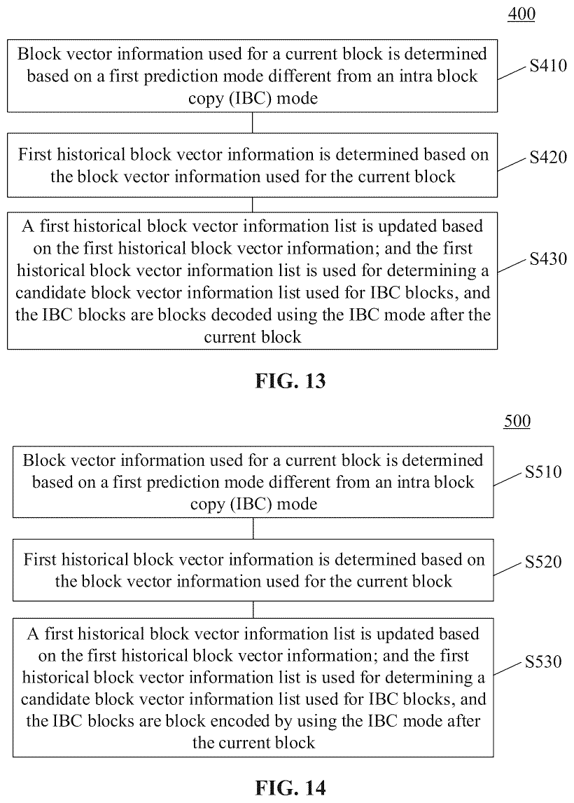

FIG. 13 is a schematic flowchart of a decoding method 400 according to the disclosure. It should be understood that the decoding method 400 may be performed by a decoder. For example, the decoding method 400 may be performed by a video decoder 122 illustrated in FIG. 1 or a video decoder 300 illustrated in FIG. 4. For convenience of description, the following explanation will use a decoder as an example. The decoding method 400 may be specifically applied to an intra prediction portion in a video decoder, for example, to an IntraTMP portion of intra prediction.

As illustrated in FIG. 13, the decoding method 400 may include part or all of following:

At operation S410, block vector information used for a current block is determined based on a first prediction mode different from an intra block copy (IBC) mode.

Exemplarily, the first prediction mode may be an intra prediction mode.

Exemplarily, the first prediction mode may be any prediction mode capable of obtaining the block vector information for the current block.

At operation S420, first historical block vector information is determined based on the block vector information used for the current block.

Exemplarily, the decoder may directly determine the block vector information used for the current block as the first historical block vector information. Alternatively, the decoder may determine part of the block vector information used for the current block as the first historical block vector information Alternatively, the decoder may determine an operation result (obtained by performing an operation on the block vector information used for the current block) as the first historical block vector information.

At operation S430, a first historical block vector information list is updated based on the first historical block vector information.

The first historical block vector information list is used for determining a candidate block vector information list used for IBC blocks, and the IBC blocks are blocks decoded using the IBC mode after the current block.

Exemplarily, the first historical block vector information list is used for determining a candidate block vector information list used for IBC blocks in the IBC-Advanced Motion Vector Prediction (AMVP) mode. In other words, the IBC blocks may be blocks decoded by using the IBC-AMVP mode after the current block. Alternatively, the first historical block vector information list is used for determining a candidate block vector information list used for IBC blocks in an IBC-Merge mode. In other words, the IBC blocks may be blocks decoded using the IBC merge mode after the current block.

Exemplarily, when the decoder decodes each IBC block, the decoder constructs the candidate block vector information list based on the first historical block vector information list, and then decodes the IBC block based on the candidate block vector information list.

If the IBC-AMVP mode is used for the IBC block, the encoder may construct a candidate block vector information list in the same manner as the decoder; obtain a reference block of the IBC block and a corresponding final block vector through processes such as hash search and full search; and encode the final block vector based on a certain prediction block vector in the candidate block vector information list, for example, by encoding a residual between the certain prediction block vector and the final block vector, to improve coding efficiency. Further, the encoder may indicate a prediction block vector index to the decoder. The prediction block vector index is used for indicating, in the candidate block vector information list, a prediction block vector used for encoding the final block vector. Accordingly, the decoder may determine the prediction block vector index by decoding a bitstream, and may determine a prediction block vector used for the IBC block in the candidate block vector information based on the prediction block vector index. Then, the decoder may obtain the final block vector of the IBC block based on the prediction block vector used for the IBC block and a block vector residual determined by decoding the bitstream, and may further determine the reference block for the IBC block based on the final block vector of the IBC block. In this way, the prediction block for the IBC block can be determined based on the reference block for the IBC block.

If the IBC-Merge mode is used for the IBC block, the encoder may construct a candidate block vector information list in the same manner as the decoder, and may then select a best block vector in the candidate block vector information list as a final block vector through an encoding processes such as SATD and RDO. The encoder may encode an index of the final block vector in the candidate block vector information list to improve encoding efficiency. Accordingly, the decoder may determine an index of the final block vector in the candidate block vector information list by decoding a bitstream, and may then determine a reference block for the IBC block based on the final block vector indicated by the index. In this way, the decoder can determine a prediction block for the IBC block based on the reference block for the IBC block.

In this embodiment, a decoder updates, based on a first prediction mode different from an IBC mode, a first historical block vector information list for determining a candidate block vector information list. Since the candidate block vector information list is a list used for IBC blocks decoded by using the IBC mode after a current block, the decoder updating the first historical block vector information list by using the first prediction mode is equivalent to the decoder enriching candidate block vector information of the IBC blocks by using the first prediction mode. Thus, decoding performance for the IBC block and decoding performance of a decoder can be improved when the decoder decodes the IBC block.

It is worth noting that if the decoder directly determines the block vector information used for the current block as the first historical block vector information, the decoder may not perform this step or may ignore this step; that is, the decoder may directly update the first historical block vector information list based on the block vector information for the current block, which is not specifically limited in the disclosure.

In this embodiment, the candidate block vectors for the IBC are enriched by using the encoding information for the IntraTMP blocks, so that the decoding performance of the decoder can be improved.

Hereinafter, the beneficial effects of the solution according to the disclosure will be described based on test results.

Table 4 shows test results obtained after the decoding method according to the disclosure is integrated into the latest ECM9.0.

TABLE 4

| | ECM9.0 | | |
|---|---|---|---|
| | Y | U | V |
| Class F | −0.01% | 0.18% | 0.21% |
| Class TGM | −0.08% | −0.08% | −0.10% |

As illustrated in Table 4, Class F and class TGM are sequence classes dedicated for screen content encoding. In the table, Y represents Luma, U represents blue chroma, and V represents red chroma. A corresponding value being negative represents performance gain. EncT represents a change in encoding complexity, and DecT represents a change in decoding complexity. From the simulation results, it can be seen that the decoding method according to the disclosure can improve the decoding performance, and particularly has a most significant gain on the TGM.

In some embodiments, the first prediction mode includes an Intra Template Matching Prediction (IntraTMP) mode.

Exemplarily, the IntraTMP mode may be a mode using any of the following techniques:
an IntraTMP adaptation technique for camera-capture content, an IntraTMP multi-candidate technique, an IntraTMP fusion prediction technique, an IntraTMP filtering technique, and a Template derived IntraTMP fusion technique.

In some embodiments, the operation S420 may include that:
at least one block vector in the first historical block vector information is determined based on at least one block vector in the block vector information used for the current block and the number of the at least one block vector.

Exemplarily, the decoder may determine, based on the number of the at least one block vector, the at least one block vector as the at least one block vector in the first historical block vector information; or may determine a portion of block vectors selected from the at least one block vector as the at least one block vector in the first historical block vector information; or may determine the at least one block vector obtained by performing calculation on the at least one block vector as the at least one block vector in the first historical block vector information.

In some embodiments, if the number of the at least one block vector is less than or equal to a first preset value, the at least one block vector is determined as the at least one block vector in the first historical block vector information.

Exemplarily, the first preset value may be implemented by pre-storing corresponding code, table, or other manners that may be used to indicate relevant information in the decoder, or the first preset value may be agreed or defined by a standard protocol.

Exemplarily, the first preset value may be any positive integer.

For example, taking the first preset value being equal to 1 as an example, if the number of the at least one block vector is less than or equal to 1, the decoder determines the at least one block vector as the at least one block vector in the first historical block vector information. In other words, only when the number of the at least one block vector is 1, the decoder may directly determine the at least one block vector as the at least one block vector in the first historical block vector information. In other words, if a prediction process for the current block is completed by using one block vector, the decoder may directly determine the one block vector as the block vector in the first historical block vector information.

For another example, taking the first preset value being equal to 2 as an example, if the number of the at least one block vector is less than or equal to 2, the decoder determines the at least one block vector as the at least one block vector in the first historical block vector information. In other words, only when the number of the at least one block vector is 1 or 2, the decoder may directly determine the at least one block vector as the at least one block vector in the first historical block vector information. In other words, if a prediction process for the current block is completed by using two block vectors, the decoder may directly determine the two block vectors as the block vectors in the first historical block vector information.

It is worth noting that the disclosure is intended to explain that the decoder may determine the at least one block vector as at least one block vector in the first historical block vector information in case that the number of the at least one block vector satisfies a specific condition. The number of the at least one block vector being less than or equal to the first preset value is merely an example of the specific condition, and should not be understood as a limitation to the disclosure. For example, in other alternative embodiments, if the number of the at least one block vector is within a preset value range, the decoder determines the at least one block vector as at least one block vector in the first historical block vector information. The preset value range may be a value set formed by multiple preset values, or the preset value range may be a preset value interval. The preset value range may be implemented by pre-storing a corresponding code, table, or other manners that can be used to indicate relevant information in the decoder; or the preset value range may be agreed or defined by a standard protocol.

In some embodiments, if the number of the at least one block vector is greater than a second preset value, the at least one block vector in the first historical block vector information is determined according to any one of following that:
a weighted average of the at least one block vector is determined as a block vector in the first historical block vector information;
one or more block vectors having a minimum template error value among the at least one block vector are determined as the at least one block vector in the first historical block vector information; or
one or more block vectors, for each of which a reference block has a minimum error value, among the at least one block vector are determined as the at least one block vector in the first historical block vector information.

Exemplarily, the second preset value may be implemented by pre-storing a corresponding code, table, or other manners that can be used to indicate relevant information in the decoder, or the second preset value may be agreed or defined by a standard protocol.

Exemplarily, the second preset value may be any positive integer.

For example, taking the second preset value being 1 as an example, if the number of the at least one block vector is greater than 1, the decoder determines the at least one block vector in the first historical block vector information according to any one of following: a weighted average of the at least one block vector is determined as the at least one block vector in the first historical block vector information; one or more block vectors having a minimum template error value among the at least one block vector are determined as the at least one block vector in the first historical block vector information; or, one or more block vectors, for each of which a reference block has a minimum error value, among the at least one block vector are determined as the at least one block vector in the first historical block vector information. Alternatively, if weighted fusion prediction is performed for the current block based on reference blocks of multiple block vectors, the block vector in the first historical block vector information is determined according to any one of following: a weighted average of the at least one block vector is determined as the block vector in the first historical block vector information; one or more block vectors having a minimum template error value among the at least one block vector is determined as at least one block vector in the first historical block vector information; or one or more block vectors, for each of which a reference block has a minimum error value, among the at least one block vector is determined as at least one block vector in the first historical block vector information.

For another example, taking the second preset value being 2 as an example, if the number of the at least one block vector is greater than 2, the at least one block vector in the first historical block vector information is determined according to any one of following: a weighted average of the at least one block vector is determined as the block vector in the first historical block vector information; one or more block vectors having a minimum template error value among the at least one block vector are determined as the at least one block vector in the first historical block vector information; or one or more block vectors, for each of which a reference block has a minimum error value, among the at least one block vector are determined as the at least one block vector in the first historical block vector information.

Exemplarily, if the number of the at least one block vector is greater than the second preset value, the decoder determines a weighted average of the at least one block vector as the block vector(s) in the first historical block vector information. For example, the decoder may perform weighted average calculation on the at least one block vector based on a weight of the at least one block vector, to obtain a weighted average of the at least one block vector. The weight of the at least one block vector may be a weight used when performing prediction for the current block based on at least one reference block for the at least one block vector. In other words, the weight of the at least one block vector may be a weight used when weighting the at least one reference block for the at least one block vector. The weight of the at least one block vector may be a predefined weight. The predefined weight may be implemented by pre-storing a corresponding code, table, or other manners that can be used to indicate relevant information in the decoder. Alternatively, the predefined weight may be agreed or defined by a standard protocol. It should be understood that the weights of different block vectors in the at least one block vector may be the same or different. For example, when the weights of all block vectors in the at least one block vector are the same, the weighted average value of the at least one block vector is the mean value of the at least one block vector.

Exemplarily, if the number of the at least one block vector is greater than the second preset value, the decoder determines one or more block vectors having a minimum template error value among the at least one block vector as the at least one block vector in the first historical block vector information. The template error value of the block vector among the at least one block vector may be a similarity (such as SAD) between a template region of the current block and a template region of the block vector. For example, the decoder may determine a block vector having a minimum template error value among the at least one block vector as the block vector in the first historical block vector information. For another example, the decoder may determine two block vectors having minimum template error values among the at least one block vector as the block vectors in the first historical block vector information.

Exemplarily, if the number of the at least one block vector is greater than the second preset value, the decoder determines one or more block vectors (for each of which the reference block has a minimum error value) among the at least one block vector as the block vector(s) in the first historical block vector information. The at least one block vector corresponds to at least one reference block. Since the current block is a block that has already been encoded and decoded, an error value of the reference block may be a similarity (such as SAD) between the reference block and a reconstructed block for the current block. For example, the decoder may determine a block vector having a minimum error value among the at least one block vector as the block vector in the first historical block vector information. For another example, the decoder may determine two block vectors having minimum error values among the at least one block vector as the block vectors in the first historical block vector information.

It is worth noting that the disclosure is intended to explain that the decoder may determine a portion of the at least one block vector or a block vector(s) obtained by calculation on the at least one block vector as a block vector(s) in the first historical block vector information in case that the number of the at least one block vector satisfies a specific condition. The number of the at least one block vector being greater than the second preset value is merely an example of the specific condition, and should not be understood as a limitation to the disclosure. For example, in other alternative embodiments, if the number of the at least one block vector is not within a preset value range, the decoder may determine a portion of the at least one block vector or a block vector(s) obtained by calculation on the at least one block vector as the block vector(s) in the first historical block vector information. The preset value range may be a value set formed by multiple preset values, or the preset value range may be a preset value interval. The preset value range may be implemented by pre-storing a corresponding code, table, or other manners that can be used to indicate relevant information in the decoder; or the preset value range may be agreed or defined by a standard protocol.

In addition, the specific use of the block vectors included in the first historical block vector information is not limited in the disclosure.

For example, if the first historical block vector information includes one block vector, the decoder may use the one block vector to perform unidirectional IBC prediction for the IBC block.

For another example, if the first historical block vector information includes two block vectors, the decoder may use the two block vectors to perform bidirectional IBC prediction for the IBC block. For example, if the first historical block vector information includes two block vectors, the decoder may determine an IBC Geometric partitioning mode (GPM) prediction block for the IBC block based on two reference blocks for the two block vectors.

In some embodiments, the operation S420 may include that:
if a prediction mode of sub-sample interpolation is used for the current block, a first block vector in the block vector information used for the current block is determined as the block vector in the first historical block vector information; or a second block vector obtained by adjusting the first block vector based on an adjustment amount of the first block vector, is determined as the block vector in the first historical block vector information.

Exemplarily, if the block vector information used for the current block only includes the first block vector, and a prediction mode of sub-sample interpolation is used for the current block, the decoder determines the first block vector or the second block vector as the block vector in the first historical block vector information. In other words, if a prediction mode of sub-sample interpolation that is based on the first block vector is used for the current block, the decoder determines the first block vector or the second block vector as the block vector in the first historical block vector information.

Exemplarily, the precision of the first block vector may be integer sample precision or sub-sample precision. The sub-sample precision may also be referred to as fractional sample precision. For example, the sub-sample precision may be ½ sample, ⅓ sample, or ¼ sample precision. If the precision of the first block vector is integer sample precision, the reference block to which the first block vector points is a block that includes integer samples and is identified according to the first block vector. If the precision of the first block vector is sub-sample precision, the reference block corresponding to the first block vector is a block that includes sub-samples and is identified according to the first block vector. Therefore, the precision of the first block vector may also be referred to as the precision of the reference block for the first block vector.

Exemplarily, the prediction mode of sub-sample interpolation may be understood as being similar to a sub-sample precision prediction mode in the inter prediction.

Exemplarily, the prediction mode of sub-sample interpolation may refer to a prediction mode in which a sub-sample block obtained after performing sub-sample interpolation is determined as a prediction block.

Exemplarily, the adjustment amount of the first block vector may include an offset direction and/or offset of the first block vector.

Exemplarily, the decoder may determine the offset direction and/or offset of the first block vector by decoding the bitstream.

Exemplarily, after the decoder obtains an interpolated picture by performing sub-sample interpolation on the current block picture in which the current block is located, the decoder may search for a reference block in the interpolated picture based on the first block vector. For example, if the precision of the first block vector is integer sample precision, the decoder adjusts the integer sample block, to which the first block vector points, based on the offset direction and offset of the first block vector to obtain a sub-sample block; and determines the obtained sub-sample block as a prediction block for the current block. For example, the decoder shifts the integer sample block (to which the first block vector points) by ½ sample to the right to obtain a sub-sample block. If the precision of the first block vector is sub-sample precision, the decoder may directly determine the sub-sample block, to which the first block vector points, as the prediction block for the current block.

In some embodiments, if a precision of the first block vector is equal to precision of the sub-sample interpolation, the first block vector is determined as the block vector in the first historical block vector information.

Exemplarily, if the precision of the first block vector is equal to the precision of the sub-sample interpolation, it indicates that the precision of the reference block (to which the first block vector points) matches the precision of the prediction block; that is, the reference block (to which the first block vector points) may be directly used as the prediction block for the current block. In other words, the precision of the first block vector is sub-sample precision, and the prediction block of the current block is directly obtained based on the block vector with sub-sample precision. In this case, when predicting the current block, the decoder may directly determine the sub-sample block, to which the first block vector points, as a prediction block for the current block. Correspondingly, the decoder may directly determine the first block vector as the block vector in the first historical block vector information.

In some embodiments, if a precision of the first block vector is greater than a precision of the sub-sample interpolation, the second block vector is determined as the block vector in the first historical block vector information.

Exemplarily, the precision of the first block vector is integer sample precision.

Exemplarily, if the precision of the first block vector is greater than the precision of the sub-sample interpolation, it indicates that the precision of the reference block, to which the first block vector points, is not matched with the precision of the prediction block; that is, the reference block, to which the first block vector points, may not be directly used as the prediction block for the current block. In other words, the prediction block for the current block is not directly obtained based on the block vector with sub-sample precision. For example, if the precision of the first block vector is integer sample precision, the decoder adjusts the integer sample block (to which the first block vector points) based on the offset direction and offset of the first block vector to obtain a sub-sample block; and determines the obtained sub-sample block as a prediction block for the current block. For example, the decoder shifts the integer sample block (to which the first block vector points) by ½ sample to the right to obtain a sub-sample block. The decoder may determine the offset direction and offset of the first block vector by decoding the bitstream. In this embodiment, the decoder may adjust the first block vector based on the offset direction and the offset to obtain a second block vector, and may then determine the second block vector as the block vector in the first historical block vector information.

In some embodiments, the operation S420 may include that:
if the first historical block vector information includes a third block vector, a precision of one or more block vectors that are in the block vector information used for the current block and are used for determining the third block vector is determined as a precision of the third block vector. The first historical block vector information includes the precision of the third block vector.

Exemplarily, if the precisions of the one or more block vectors are the same, the precision of the one or more block vectors is determined as the precision of the third block vector.

Exemplarily, if the third block vector is the first block vector in the block vector information used for the current block, the decoder may determine the precision of the first block vector as the precision of the third block vector. If the third block vector is a block vector obtained by a decoder performing a weighted average on multiple block vectors in block vector information used for the current block, the decoder may determine the precision of the multiple block vectors as the precision of the third block vector. If the third block vector is the second block vector obtained by adjusting the first block vector in the block vector information used for the current block, the decoder may determine the precision of the second block vector as the precision of the third block vector.

In some embodiments, the operation S420 may include that:
at least one of following in the block vector information used for the current block is determined as information in the first historical block vector information:

coordinate information of the current block;
an identifier indicating whether to perform illumination compensation on a prediction block for the current block;
an identifier indicating whether to perform filtering on the prediction block for the current block;
an identifier indicating whether to flip a reference block for the current block;
an identifier indicating whether a prediction mode used for the current block is the IBC mode;
an identifier indicating whether the prediction mode used for the current block is the first prediction mode;
an index indicating the prediction mode used for the current block; or
an index indicating weights of multiple reference blocks used for the current block.

Exemplarily, the coordinate information of the current block includes coordinate information of at least one of following positions:
a top-left corner, a bottom-left corner, a top-right corner, a bottom-right corner, and a center point of the current block.

Exemplarily, the identifier indicating whether to perform illumination compensation on the prediction block for the current block includes:
an identifier indicating whether to perform local illumination compensation (LIC) on the prediction block for the current block.

Exemplarily, the index indicating the prediction mode used for the current block may include at least one of following: an index indicating the first prediction mode used for the current block, an index indicating a sub-mode that is used for the current block and belongs to the first prediction mode, or an index indicating that the IBC mode is used for the current block. The sub-mode may be a mode using any of the following techniques: an IntraTMP adaptation technique for camera-capture content, an IntraTMP multi-candidate technique, an IntraTMP fusion prediction technique, an IntraTMP filtering technique, and a Template derived IntraTMP fusion technique.

It is worth noting that the decoder directly determines information in the block vector information used for the current block as information in the first historical block vector information, which may also be understood as that: the decoder inherits the information in the block vector information used for the current block or other descriptions having similar meanings, which is not specifically limited in the disclosure.

In some embodiments, the operation S420 may include that:
a bitstream is decoded to determine a first identifier; and
if the first identifier indicates updating the first historical block vector information
list based on the first prediction mode, the first historical block vector information is determined based on the block vector information used for the current block.

Exemplarily, the decoder decodes the bitstream to determine the first identifier. If the first identifier indicates updating the first historical block vector information list based on the first prediction mode, the decoder determines the first historical block vector information based on the block vector information used for the current block, and then updates a first historical block vector information list based on the first historical block vector information. Otherwise, the decoder does not update the first historical block vector information list by using the first prediction mode.

Exemplarily, when the value of the first identifier is a first value, it indicates updating the first historical block vector information list based on the first prediction mode; and when the value of the first identifier is a second value, it indicates not updating the first historical block vector information list based on the first prediction mode. The first value is 1 and the second value is 0; or the first value is 0 and the second value is 1. When the first identifier does not exist in the bitstream obtained by the decoder, the value of the first identifier may be the first value by default, or the value of the first identifier may be the second value by default.

Exemplarily, when the first identifier indicates activation or enabling, it indicates updating the first historical block vector information list based on the first prediction mode; and when the first identifier indicates deactivation or disabling, it indicates not updating the first historical block vector information list based on the first prediction mode. When the first identifier does not exist in the bitstream obtained by the decoder, the first identifier may indicate activation or enabling by default, or the first identifier may indicate deactivation or disabling by default.

Exemplarily, the first identifier may be a sequence-level identifier. For example, the first identifier indicates whether a current sequence to which the current block belongs allows updating the first historical block vector information list based on the first prediction mode. The decoder may determine the first identifier by decoding a Sequence Parameter Set (SPS) in the bitstream. In other words, the first identifier may be carried within the SPS in the bitstream.

Exemplarily, the first identifier may be a picture-level identifier. For example, the first identifier indicates whether a current picture to which the current block belongs allows updating the first historical block vector information list based on the first prediction mode. The decoder may determine the first identifier by decoding picture header information in the bitstream. In other words, the first identifier may be carried within the picture header information in the bitstream.

Exemplarily, the first identifier may be a slice-level identifier. For example, the first identifier indicates whether a current slice to which the current block belongs allows updating the first historical block vector information list based on the first prediction mode. The decoder may partition the current picture to obtain the current slice. The decoder may determine the first identifier by decoding slice-level information in the bitstream. In other words, the first identifier may be carried within the slice-level information in the bitstream.

Exemplarily, the first identifier may be a picture block-level identifier. For example, the first identifier indicates whether the current block allows updating the first historical block vector information list based on the first prediction mode. The decoder may determine the first identifier by decoding block-level information of the current block in the bitstream. In other words, the first identifier may be carried within the block-level information of the current block in the bitstream.

It is worth noting that when the first identifier is a sequence-level identifier, the decoder may further decode the bitstream to determine at least one of a picture-level identifier, a slice-level identifier, or a picture block-level identifier. For example, taking the decoder further decoding the bitstream to determine a picture-level identifier and a picture block-level identifier as an example, if the first identifier indicates that a current sequence to which the current block belongs allows updating the first historical block vector information list based on the first prediction mode, the decoder decodes the bitstream to determine the picture-level identifier; if the picture-level identifier indicates that the current picture to which the current block belongs allows updating the first historical block vector information list based on the first prediction mode, the decoder decodes the bitstream to determine the picture block-level identifier. The picture block-level identifier indicates whether the current block allows updating the first historical block vector information list based on the first prediction mode. Of course, the sequence-level identifier, the picture-level identifier, or the picture block-level identifier may be an optional identifier, which is not specifically limited in the disclosure.

In some embodiments, the operation S420 may include that:
if the number of block vectors in the block vector information used for the current block is less than or equal to a third preset value, the first historical block vector information is determined based on the block vector information used for the current block.

Exemplarily, the third preset value may be implemented by pre-storing a corresponding code, table, or other manners that can be used to indicate relevant information in the decoder; or the third preset value may be agreed or defined by a standard protocol.

Exemplarily, the third preset value may be any positive integer.

For example, the third preset value may be greater than the first preset value mentioned above. For another example, the third preset value may be greater than or equal to the second preset value mentioned above.

In some embodiments, the operation S420 may include that:
the first historical block vector information is determined based on the block vector information used for the current block if at least one of following conditions is satisfied:
an area of the current block is greater than or equal to a first threshold;
a width of the current block is greater than or equal to a second threshold;
a height of the current block is greater than or equal to a third threshold; or
a type of a current picture to which the current block belongs is a preset type.

Exemplarily, the area of the current block is the width of the current block multiplied by the height of the current block.

Exemplarily, the width of the current block refers to the number of samples included in the width dimension of the current block.

Exemplarily, the height of the current block refers to the number of samples included in the height dimension of the current block.

Exemplarily, if the area of the current block is greater than or equal to a preset first threshold, the decoder determines the first historical block vector information based on the block vector information used for the current block. In other words, the decoder updates the first historical block vector information list based on the first historical block vector information only when the area of the current block is greater than or equal to the preset first threshold.

Exemplarily, if the width of the current block is greater than or equal to a second threshold and the height of the current block is greater than or equal to a third threshold, the decoder determines the first historical block vector information based on the block vector information used for the current block. In other words, the decoder updates the first historical block vector information list based on the first historical block vector information only when the width of the current block is greater than or equal to the second threshold and the height of the current block is greater than or equal to the third threshold.

Exemplarily, if the type of the current picture to which the current block belongs is a preset type, the decoder determines the first historical block vector information based on the block vector information used for the current block. The preset type may be an I frame, a B frame, or a P frame. In other words, the decoder updates the first historical block vector information list based on the first historical block vector information only when the type of the current picture to which the current block belongs is the preset type. For example, the use of the decoding method according to the disclosure may be restricted based on a picture type. For example, the decoder is allowed to use the decoding method according to the disclosure only when the type of the current picture is an I frame; and the decoder is not allowed to use the decoding method according to the disclosure when the type of the current picture is a B frame or a P frame.

Exemplarily, the first threshold, the second threshold, the third threshold, or the preset type may be a preset value, and may be implemented by pre-storing a corresponding code, table, or other manners that can be used to indicate relevant information in the decoder, or may be agreed or defined by a standard protocol.

It is worth noting that the disclosure is intended to explain that: in case that the decoder can satisfy a specific condition, the decoder can determine the first historical block vector information based on the block vector information used for the current block. In other words, the decoder updates the first historical block vector information list based on the first historical block vector information only when the specific condition can be satisfied. The above conditions are merely examples of the specific condition, and should not be understood as a limitation to the disclosure. For example, in other alternative embodiments, if at least one of following is satisfied: the area of the current block is less than or equal to a fourth threshold, the width of the current block is less than or equal to a fifth threshold, the height of the current block is less than or equal to a sixth threshold, and the area of the current block is within a preset value range, the decoder determines the first historical block vector information based on the block vector information used for the current block, or the decoder updates the first historical block vector information list based on the first historical block vector information. The preset value range may be a value set formed by multiple preset values, or the preset value range may be a preset value interval. The fourth threshold to the sixth threshold may be implemented by pre-storing a corresponding code, table, or other manners that can be used to indicate relevant information in the decoder, or may be agreed or defined by a standard protocol.

In some embodiments, the operation S430 may include that:
if the first historical block vector information list includes the first historical block vector information, the first historical block vector information is moved to an end of the first historical block vector information list.

Exemplarily, the end of the first historical block vector information list is a last position in the first historical block vector information list.

Exemplarily, when determining the candidate block vector information list based on the first historical block vector information list, the decoder may select, in the order of back to front, historical block vector information from the first historical block vector information list as candidate vector information in the candidate vector information list. For example, when determining the candidate block vector information list based on the first historical block vector information list, the decoder selects, in the order of back to front, historical block vector information from the first historical block vector information list as candidate vector information in the candidate vector information list; and then: if the first historical block vector information list includes the first historical block vector information, the decoder moves the first historical block vector information to the end of the first historical block vector information list.

Exemplarily, the historical block vector information in the first historical block vector information list is updated according to a first-in-first-out mechanism, that is, the historical block vector information added earliest is the first to be removed. The historical block vector information foremost in the first historical block vector information list is the historical block vector information added earliest, and is also the historical block vector information earliest removed when updating the first historical block vector information list; and the historical block vector information at the end of the first historical block vector information list is the historical block vector information added latest. In this case, the decoder moving the first historical block vector information to the end of the first historical block vector information list is equivalent to the decoder adjusting the first historical block vector information to be latest added historical block vector information.

Exemplarily, if the first historical block vector information list includes block vector information identical to the first historical block vector information, the first historical block vector information list includes the first historical block vector information. The determination of whether the block vector information is the same may be achieved in the following manner:
if the numbers of block vectors existing in two pieces of block vector information are different, it is determined that the two pieces of block vector information are different; and
if the numbers of block vectors existing in the two pieces of block vector information are the same, whether there are different block vectors in the two pieces of block vector information is determined; if there are different block vectors in the two pieces of block vector information, it is determined that the two pieces of block vector information are different; otherwise, it is determined that the two pieces of block vector information are the same.

Of course, in other alternative embodiments, the determination of whether the block vector information is the same may also be performed in other ways, which is not limited in the disclosure.

For example, if an illumination compensation flag bit, a filtering flag bit, or a flip flag bit in a piece of block vector information is different from that in another piece of block vector information, it is determined that these two pieces of block vector information are different from each other.

It is worth noting that the disclosure is intended to explain that: if the first historical block vector information list includes the first historical block vector information, the decoder adjusts the first historical block vector information to be latest added historical block vector information. Therefore, in other alternative embodiments, when the historical block vector information at the end of the first historical block vector information list is the historical block vector information added earliest, and is also the historical block vector information earliest removed when updating the first historical block vector information list, and when the first historical block vector information list includes the first historical block vector information, the decoder may move the first historical block vector information to the foremost in the first historical block vector information list, which is not specifically limited in the disclosure.

In some embodiments, the operation S430 may include that:
if the number of pieces of historical block vector information in the first historical block vector information list is less than a fourth preset value, the first historical block vector information is added to the first historical block vector information list; otherwise, foremost historical block vector information in the first historical block vector information list is moved out, and the first historical block vector information is added to an end of the first historical block vector information list.

Exemplarily, the fourth preset value may be implemented by pre-storing a corresponding code, table, or other manners that can be used to indicate relevant information in the decoder, or the fourth preset value may be agreed or defined by a standard protocol.

Exemplarily, the fourth preset value may be any positive integer.

For example, assuming that the fourth preset value is denoted as N. If the number of pieces of historical block vector information in the first historical block vector information list is less than N, the decoder adds the first historical block vector information to the first historical block vector information list; otherwise, the decoder removes foremost historical block vector information from the first historical block vector information list, and adds the first historical block vector information to an end of the first historical block vector information list.

Exemplarily, the fourth preset value may also be referred to as a length or a maximum length of the first historical block vector information list. In other words, if the number of pieces of historical block vector information in the first historical block vector information list is less than the fourth preset value, it indicates that the first historical block vector information list is not full; in this case, the decoder may directly add the first historical block vector information to the first historical block vector information list. If the number of pieces of historical block vector information in the first historical block vector information list is equal to the fourth preset value, it indicates that the first historical block vector information list is full; in this case, the decoder needs to firstly remove the foremost historical block vector information in the first historical block vector information list, and then adds the first historical block vector information to the end of the first historical block vector information list.

In some embodiments, the first historical block vector information list is a common historical block vector information list for both the first prediction mode and the IBC mode.

Exemplarily, the first historical block vector information list is a historical block vector information list commonly maintained for both the first prediction mode and the IBC mode. In other words, the decoder may update the first historical block vector information list based on the first prediction mode and the IBC mode.

In some embodiments, when the first historical block vector information list is used for determining the candidate block vector information list, a priority of second historical block vector information that is in the first historical block vector information list and belongs to the first prediction mode is lower than a priority of third historical block vector information that is in the first historical block vector information list and belongs to the IBC mode.

Exemplarily, when the decoder determines the candidate block vector information list based on the first historical block vector information list, a priority of second historical block vector information that is in the first historical block vector information list and belongs to the first prediction mode is lower than a priority of third historical block vector information that is in the first historical block vector information list and belongs to the IBC mode. In other words, when the decoder determines the candidate block vector information list based on the first historical block vector information list, the decoder preferentially takes the third historical block vector information in the first historical block vector information list as candidate block vector information in the candidate block vector information list. In other words, when the decoder determines the candidate block vector information list based on the first historical block vector information list, the decoder preferentially adds the third historical block vector information in the first historical block vector information list to the candidate block vector information list.

Exemplarily, the decoder may determine a prediction mode to which the historical block vector information 1 belongs based on at least one of the following pieces of information included in the historical block vector information 1 in the first historical block vector information list:
an index 1 indicating a prediction mode used for the historical block vector information 1, an index 2 indicating whether the first prediction mode is used for the historical block vector information 1, an index 3 indicating whether the IBC mode is used for the historical block vector information 1, or other information.

For example, if the index 1 indicates the first prediction mode, the historical block vector information 1 belongs to the first prediction mode; and if the index 1 indicates the IBC mode, the historical block vector information 1 belongs to the IBC mode. For another example, if the index 2 indicates that the first prediction mode is used, the historical block vector information 1 belongs to the first prediction mode; and if the index 2 indicates that the first prediction mode is not used, the historical block vector information 1 belongs to the IBC mode. For another example, if the index 3 indicates that the IBC mode is used, the historical block vector information 1 belongs to the IBC mode; and if the index 3 indicates that the IBC mode is not used, the historical block vector information 1 belongs to the first prediction mode.

It is worth noting that the disclosure is intended to explain that: pieces of historical block vector information belonging to different prediction modes in the first historical block vector information list may be added to the candidate block vector information list using different selection strategies. The priorities are merely examples of the selection strategies, and should not be understood as a limitation to the disclosure. For example, in other alternative embodiments, the way of selecting the second historical block vector information that is in the first historical block vector information list and belongs to the first prediction mode may be different from the way of selecting the third historical block vector information that is in the first historical block vector information list and belongs to the IBC mode. For example, when the decoder determines the candidate block vector information list based on the first historical block vector information list, the number of pieces of second historical block vector information that is in the first historical block vector information list and belongs to the first prediction mode is smaller than the number of pieces of third historical block vector information that is in the first historical block vector information list and belongs to the IBC mode.

In this embodiment, the decoder only needs to maintain one common historical block vector information list for both the first prediction mode and the IBC mode, which can reduce the complexity in maintaining the historical block vector information list by the decoder, and further improve the decoding efficiency and decoding performance of the decoder.

In some embodiments, the first historical block vector information list is a historical block vector information list for the first prediction mode, and both the first historical block vector information and a second historical block vector information list for the IBC mode are used to determine the candidate block vector information list.

Exemplarily, a decoder maintains the first historical block vector information list for the first prediction mode and maintains the second historical block vector information list for the IBC mode. In other words, the decoder updates the first historical block vector information list based on the first prediction mode, and updates the second historical block vector information list based on the IBC mode. In other words, the decoder needs to maintain a historical block vector information list for each of the first prediction mode and the IBC mode.

In some embodiments, a priority of the first historical block vector information list in determining the candidate block vector information list is lower than a priority of the second historical block vector information list in determining the candidate block vector information list.

Exemplarily, when the decoder determines the candidate block vector information list based on the first historical block vector information list and the second historical block vector information list, a priority of the first historical block vector information list is lower than a priority of the second historical block vector information list. In other words, when the decoder determines the candidate block vector information list based on the first historical block vector information list and the second historical block vector information list, the decoder preferentially takes the historical block vector information in the second historical block vector information list as the candidate block vector information in the candidate block vector information list. In other words, when the decoder determines the candidate block vector information list based on the first historical block vector information list and the second historical block vector information list, the decoder preferentially adds the historical block vector information in the second historical block vector information list to the candidate block vector information list.

It is worth noting that the disclosure is intended to explain that: for the first historical block vector information list and the second historical block vector information list, different selection strategies may be used to add the historical block vector information in the respective lists to the candidate block vector information list. The priorities are merely examples of the selection strategies, and should not be understood as a limitation to the disclosure. For example, in other alternative embodiments, the way of selecting historical block vector information from the first historical block vector information list may be different from the way of selecting historical block vector information from the second historical block vector information list. For example, when the decoder determines the candidate block vector information list based on the first historical block vector information list and the second historical block vector information list, the number of pieces of historical block vector information selected from the first historical block vector information list may be smaller than the number of pieces of historical block vector information selected from the second historical block vector information list.

In this embodiment, the decoder maintains different historical block vector information lists for the first prediction mode and the IBC mode respectively, so that information for constructing the candidate block vector information list can be enriched, and decoding performance of the decoder can be improved.

In some embodiments, a current picture to which the current block belongs is partitioned into multiple regions. The multiple regions include a region where the current block is located, and the first historical block vector information list is a historical block vector information list corresponding to the region where the current block is located.

Exemplarily, the multiple regions correspond to multiple historical block vector information lists. The multiple historical block vector information lists are historical block vector information lists for the IBC mode. Alternatively, the multiple historical block vector information lists are historical block vector information lists for the first prediction mode. Alternatively, the multiple historical block vector information lists are common historical block vector information lists for both the IBC mode and the first prediction mode.

For example, if the current picture is a Gradual Decoder Refresh (GDR) picture, the current picture to which the current block belongs is partitioned into multiple regions. The multiple regions include a region where the current block is located, and the first historical block vector information list is a historical block vector information list corresponding to the region where the current block is located. For example, the decoder may partition the current picture into two regions according to a partitioning boundary, which are denoted as a clean area and a dirty area. Only intra prediction can be used for a picture block in the clean area, and any information in the dirty area, including reconstructed samples, MVs, coding modes, reference lists, and the like, cannot be used. In other words, the decoder may maintain two historical block vector information lists corresponding to the two regions for the current picture, and the first historical block vector information list is a historical block vector information list corresponding to the region in which the current block is located. In other words, the decoder may update the historical block vector information list corresponding to the region in which the current block is located based on the first historical block vector information according to the position of the current block. For example, if the current block is located within the clean area, the decoder may update a historical block vector information list corresponding to the clean area based on the first historical block vector information; otherwise, the decoder updates a historical block vector information list corresponding to the dirty area based on the first historical block vector information.

The decoding method according to the disclosure is described hereinafter in conjunction with embodiments.

### Embodiment 1

In this embodiment, assuming that the first prediction mode described above is the Intra TMP mode, then the current block described above is an IntraTMP coding block. That is, in a method of storing information such as the block vector of the IntraTMP coding block in an IBC historical block vector list, the information such as the block vector of the IntraTMP coding block is used to enrich the candidate block vectors for the IBC, thereby improving decoding efficiency.

Specifically, the decoding method includes the following operations:

### Operation 1:

Decoding of the IntraTMP coding block is completed, and a block vector to be stored is confirmed.

For example, prediction for the IntraTMP coding block is completed by using a single block vector, and the block vector may be stored directly. For another example, sub-sample interpolation prediction based on a single block vector with integer sample precision is used for the IntraTMP coding block, and the block vector with integer sample precision may be adjusted according to a type of the sub-sample interpolation and then stored. For another example, weighted fusion prediction of reference blocks based on multiple block vectors is used for the IntraTMP coding block, and a block vector having a minimum template error value among these block vectors can be stored.

### Operation 2:

Information associated with the block vector to be stored is determined.

For example, coordinates of a current coding block (e.g., coordinates of a center point of a current block) may be stored. As another example, the precision of the block vector determined in Operation 1 may be stored. For another example, whether the LIC method, the filtering method, or the like is used for the current coding block may be stored. As another example, whether a reference block is flipped for the current coding block may be stored. As another example, a flag bit indicating whether the block vector determined in Operation 1 belongs to the IBC may be introduced. As another example, weight indexes of bidirectional weighting for the current block may be stored.

The block vector determined in Operation 1 and the information associated with the block vector determined in Operation 2 may constitute block vector information.

### Operation 3:

The decoder may determine whether to store the block vector information (i.e., including the block vector determined in Operation 1 and the information associated with the block vector determined in Operation 2) into an IBC historical block vector list according to a condition. For example, the block vector information may be stored into the IBC historical block vector list only when the size of the current block is not greater than W×H.

### Operation 4:

When the condition is satisfied, the block vector information is stored into the IBC historical block vector list. If the block vector information is already in the historical block vector information list, this piece of block vector information in the list is moved to the end of the list; otherwise, it is firstly determined whether the IBC historical block vector list is full, and if it is full, foremost block vector information of the list is moved out, and then the block vector information is added to the end of the IBC historical block vector list to complete the update of the IBC historical block vector list.

### Operation 5:

If the current picture is a GDR picture, the current picture will be partitioned into a clean area and a dirty area according to a partitioning boundary. The decoder maintains two IBC historical block vector lists. The block vector information may be stored to different lists according to the position of the current block in the current picture. For example, if the current block is located in a clean area, the block vector information is stored into an IBC historical block vector list 1; otherwise, the block vector information is stored into IBC historical block vector list 2.

### Operation 6:

A candidate block vector list is constructed for the IBC coding block and the block vector information in the IBC historical block vector list is as a candidate to complete prediction for the IBC coding block.

It should be understood that Embodiment 1 merely illustrates an example of the disclosure and should not be construed as a limitation of the disclosure. For example, in other alternative embodiments, Embodiment 1 may be adapted, adjusted, or replaced according to one or more of the following alternatives to form a new implementation.

### Alternative 1:

In Operation 1, if weighted fusion prediction of reference blocks based on multiple block vectors is used for the IntraTMP coding block, an average of these block vectors can be stored.

### Alternative 2:

In Operation 1, if weighted fusion prediction of reference blocks based on multiple block vectors is used for the IntraTMP coding block, two block vectors having minimum template error values among these block vectors can be stored. The two block vectors may be used for bidirectional IBC prediction, i.e. an IBC-GPM prediction block, etc. may be formed by two IBC reference blocks.

### Alternative 3:

In Operation 1, if weighted fusion prediction of reference blocks based on multiple block vectors is used for the IntraTMP coding block, an optimal block vector may be selected and stored according to a current reconstructed block. For example, an error between a reference block corresponding to each block vector and a current reconstructed block is calculated, and the error may be calculated by SAD. The block vector with the minimum error is the optimal block vector and is stored.

### Alternative 4:

In Operation 2, a flag bit indicating whether the block vector determined in Operation 1 belongs to the IntraTMP may be introduced. When constructing a candidate block vector list or adding a historical block vector candidate for an IBC coding block, block vectors belonging to different decoding modes may be processed differently. For example, all block vectors belonging to the IBC mode in the IBC historical block vector list are added firstly, and then block vectors belonging to the IntraTMP mode are added.

### Alternative 5:

The determination condition in Operation 3 may be that the width of the current block is less than W and the height of the current block is less than H, or other conditions related to the width or the height.

### Alternative 6:

Instead, an IntraTMP historical block vector list may be constructed, which is different from the IBC historical block vector list, and block vector information for the IntraTMP coding block is stored in the IntraTMP historical block vector list.

### Alternative 7:

The determination condition in Operation 3 may include: determining whether to store block vector information based on the prediction mode of the current IntraTMP coding block. For example, weighted fusion prediction of reference blocks based on multiple block vectors is used for the IntraTMP coding block, and block vector information is not stored into the historical block vector list.

### Alternative 8:

In Operation 3, the determination condition may include using a sequence-level flag bit, a picture-level flag bit, a slice-level flag bit, or a picture block-level flag bit to indicate whether to allow updating the IBC historical block vector list based on the IntraTMP mode.

Hereinafter, an encoding method according to embodiments of the disclosure will be described from the perspective of an encoder with reference to FIG. 14.

FIG. 14 is a schematic flowchart of an encoding method 500 according to the disclosure.

It should be understood that the encoding method 500 may be performed by an encoder. For example, the encoding method 500 may be performed by a video encoder 112 illustrated in FIG. 1 or a video encoder 200 illustrated in FIG. 2.

As illustrated in FIG. 14, the encoding method 500 may include operations S510 to S530.

At S510, block vector information used for a current block is determined based on a first prediction mode different from an intra block copy (IBC) mode.

At S520, first historical block vector information is determined based on the block vector information used for the current block.

At S530, a first historical block vector information list is updated based on the first historical block vector information.

The first historical block vector information list is used for determining a candidate block vector information list used for IBC blocks, and the IBC blocks are block encoded by using the IBC mode after the current block.

In some embodiments, the first prediction mode includes an Intra Template Matching Prediction (IntraTMP) mode.

In some embodiments, the operation S520 may include that:
at least one block vector in the first historical block vector information is determined based on at least one block vector in the block vector information used for the current block and the number of the at least one block vector.

In some embodiments, if the number of the at least one block vector is less than or equal to a first preset value, the at least one block vector is determined as the block vector(s) in the first historical block vector information.

In some embodiments, if the number of the at least one block vector is greater than a second preset value, the block vector(s) in the first historical block vector information is determined according to any one of following:
a weighted average of the at least one block vector is determined as a block vector in the first historical block vector information;
one or more block vectors having a minimum template error value among the at least one block vector are determined as the at least one block vector in the first historical block vector information; or
one or more block vectors, for each of which a reference block has a minimum error value, among the at least one block vector are determined as the at least one block vector in the first historical block vector information.

In some embodiments, the operation S520 may include:
if a prediction mode of sub-sample interpolation is used for the current block, a first block vector in the block vector information used for the current block is determined as the block vector in the first historical block vector information; or a second block vector obtained by adjusting the first block vector based on an adjustment amount of the first block vector, is determined as the block vector in the first historical block vector information.

In some embodiments, if precision of the first block vector is equal to precision of the sub-sample interpolation, the first block vector is determined as the block vector in the first historical block vector information.

In some embodiments, if precision of the first block vector is greater than precision of the sub-sample interpolation, the second block vector is determined as the block vector in the first historical block vector information.

In some embodiments, the operation S520 may include that:
if the first historical block vector information includes a third block vector, a precision of one or more block vectors that are in the block vector information used for the current block and are used for determining the third block vector is determined as a precision of the third block vector. The first historical block vector information includes the precision of the third block vector.

In some embodiments, the operation S520 may include that:
at least one of following in the block vector information used for the current block is determined as information in the first historical block vector information:
coordinate information of the current block;
an identifier indicating whether to perform illumination compensation on a prediction block for the current block;
an identifier indicating whether to perform filtering on the prediction block for the current block;
an identifier indicating whether to flip a reference block for the current block;
an identifier indicating whether a prediction mode used for the current block is the IBC mode;
an identifier indicating whether the prediction mode used for the current block is the first prediction mode;
an index indicating the prediction mode used for the current block; or
an index indicating weights of multiple reference blocks used for the current block.

In some embodiments, the method 500 further includes that:
a first identifier is encoded.

The first identifier indicates updating the first historical block vector information list based on the first prediction mode.

In some embodiments, the operation S520 may include that:
if the number of block vectors in the block vector information used for the current
block is less than or equal to a third preset value, the first historical block vector information is determined based on the block vector information used for the current block.

In some embodiments, the operation S520 may include that:
the first historical block vector information is determined based on the block vector information used for the current block if at least one of following conditions is satisfied:
an area of the current block is greater than or equal to a first threshold;
a width of the current block is greater than or equal to a second threshold;
a height of the current block is greater than or equal to a third threshold; or
a type of a current picture to which the current block belongs is a preset type.

In some embodiments, the operation S530 may include that:
if the first historical block vector information list includes the first historical block vector information, the first historical block vector information is moved to an end of the first historical block vector information list.

In some embodiments, the operation S530 may include that:
if the number of pieces of historical block vector information in the first historical block vector information list is less than a fourth preset value, the first historical block vector information is added to the first historical block vector information list; otherwise, foremost historical block vector information in the first historical block vector information list is moved out, and the first historical block vector information is added to an end of the first historical block vector information list.

In some embodiments, the first historical block vector information list is a common historical block vector information list for both the first prediction mode and the IBC mode.

In some embodiments, when the first historical block vector information list is used for determining the candidate block vector information list, a priority of second historical block vector information that is in the first historical block vector information list and belongs to the first prediction mode is lower than a priority of third historical block vector information that is in the first historical block vector information list and belongs to the IBC mode.

In some embodiments, the first historical block vector information list is a historical block vector information list for the first prediction mode, and both the first historical block vector information and a second historical block vector information list for the IBC mode are used to determine the candidate block vector information list.

In some embodiments, a priority of the first historical block vector information list in determining the candidate block vector information list is lower than a priority of the second historical block vector information list in determining the candidate block vector information list.

In some embodiments, a current picture to which the current block belongs is partitioned into multiple regions. The multiple regions include a region where the current block is located, and the first historical block vector information list is a historical block vector information list corresponding to the region where the current block is located.

It should be understood that the encoding method may be understood as an inverse process of the decoding method, and therefore, the related contents of the decoding method 400 may be referred to for the specific solution of the encoding method 500, which will not be described herein again for convenience of description.

The encoding method according to the disclosure is described hereinafter in conjunction with embodiments.

### Embodiment 1

In this embodiment, assuming that the first prediction mode described above is the IntraTMP mode, then the current block described above is an IntraTMP coding block. That is, in a method of storing information such as the block vector of the IntraTMP coding block in an IBC historical block vector list, the information such as the block vector of the IntraTMP coding block is used to enrich the candidate block vectors for the IBC, thereby improving encoding efficiency.

Specifically, the encoding method includes the following operations:

### Operation 1:

Encoding of the IntraTMP coding block is completed, and a block vector to be stored is confirmed.

For example, prediction for the IntraTMP coding block is completed by using a single block vector, and the block vector may be stored directly. For another example, sub-sample interpolation prediction based on a single block vector with integer sample precision is used for the IntraTMP coding block, and the block vector with integer sample precision may be adjusted according to a type of the sub-sample interpolation and then stored. For another example, weighted fusion prediction of reference blocks based on multiple block vectors is used for the IntraTMP coding block, and a block vector having a minimum template error value among these block vectors can be stored.

### Operation 2:

Information associated with the block vector to be stored is determined.

For example, coordinates of a current coding block (e.g., coordinates of a center point of a current block) may be stored. As another example, the precision of the block vector determined in Operation 1 may be stored. For another example, whether the LIC method, the filtering method, or the like is used for the current coding block may be stored. As another example, whether a reference block is flipped for the current coding block may be stored. As another example, a flag bit indicating whether the block vector determined in Operation 1 belongs to the IBC may be introduced. As another example, weight indexes of bidirectional weighting for the current block may be stored.

The block vector determined in Operation 1 and the information associated with the block vector determined in Operation 2 may constitute block vector information.

### Operation 3:

The encoder may determine whether to store the block vector information (i.e., including the block vector determined in Operation 1 and the information associated with the block vector determined in Operation 2) into an IBC historical block vector list according to a condition. For example, the block vector information may be stored into the IBC historical block vector list only when the size of the current block is not greater than W×H.

### Operation 4:

When the condition is satisfied, the block vector information is stored into the IBC historical block vector list. If the block vector information is already in the historical block vector information list, this piece of block vector information in the list is moved to the end of the list; otherwise, it is firstly determined whether the IBC historical block vector list is full, and if it is full, foremost block vector information of the list is moved out, and then the block vector information is added to the end of the IBC historical block vector list to complete the update of the IBC historical block vector list.

### Operation 5:

If the current picture is a GDR picture, the current picture will be partitioned into a clean area and a dirty area according to a partitioning boundary. The encoder maintains two IBC historical block vector lists. The block vector information may be stored to different lists according to the position of the current block in the current picture. For example, if the current block is located in a clean area, the block vector information is stored into an IBC historical block vector list 1; otherwise, the block vector information is stored into IBC historical block vector list 2.

### Operation 6:

The IBC coding block constructs a candidate block vector list and uses block vector information in the IBC historical block vector list as a candidate to complete prediction for the IBC coding block.

It should be understood that Embodiment 2 merely illustrates an example of the disclosure and should not be construed as a limitation of the disclosure. For example, in other alternative embodiments, Embodiment 1 may be adapted, adjusted, or replaced according to one or more of the following alternatives to form a new implementation.

### Alternative 1:

In Operation 1, if weighted fusion prediction of reference blocks based on multiple block vectors is used for the IntraTMP coding block, an average of these block vectors can be stored.

### Alternative 2:

In Operation 1, if weighted fusion prediction of reference blocks based on multiple block vectors is used for the IntraTMP coding block, two block vectors having minimum template error values among these block vectors can be stored. The two block vectors may be used for bidirectional IBC prediction, i.e. an IBC-GPM prediction block, etc. may be formed by two IBC reference blocks.

### Alternative 3:

In Operation 1, if weighted fusion prediction of reference blocks based on multiple block vectors is used for the IntraTMP coding block, an optimal block vector may be selected and stored according to a current reconstructed block. For example, an error between a reference block corresponding to each block vector and a current reconstructed block is calculated, and the error may be calculated by SAD. The block vector with the minimum error is the optimal block vector and is stored.

### Alternative 4:

In Operation 2, a flag bit indicating whether the block vector determined in Operation 1 belongs to the IntraTMP may be introduced. When constructing a candidate block vector list or adding a historical block vector candidate for an IBC coding block, block vectors belonging to different encoding modes may be processed differently. For example, all block vectors belonging to the IBC mode in the IBC historical block vector list are added firstly, and then block vectors belonging to the IntraTMP mode are added.

### Alternative 5:

The determination condition in Operation 3 may be that the width of the current block is less than W and the height of the current block is less than H, or other conditions related to the width or the height.

### Alternative 6:

Instead, an IntraTMP historical block vector list may be constructed, which is different from the IBC historical block vector list, and block vector information for the IntraTMP coding block may be stored in the IntraTMP historical block vector list.

### Alternative 7:

The determination condition in Operation 3 may include determining whether to store block vector information based on the prediction mode of the current IntraTMP coding block. For example, weighted fusion prediction of reference blocks based on multiple block vectors is used for the IntraTMP coding block, and block vector information is not stored into the historical block vector list.

### Alternative 8:

In Operation 3, the determination condition may include using a sequence-level flag bit, a picture-level flag bit, a slice-level flag bit, or a picture block-level flag bit to indicate whether to allow updating the IBC historical block vector list based on the IntraTMP mode.

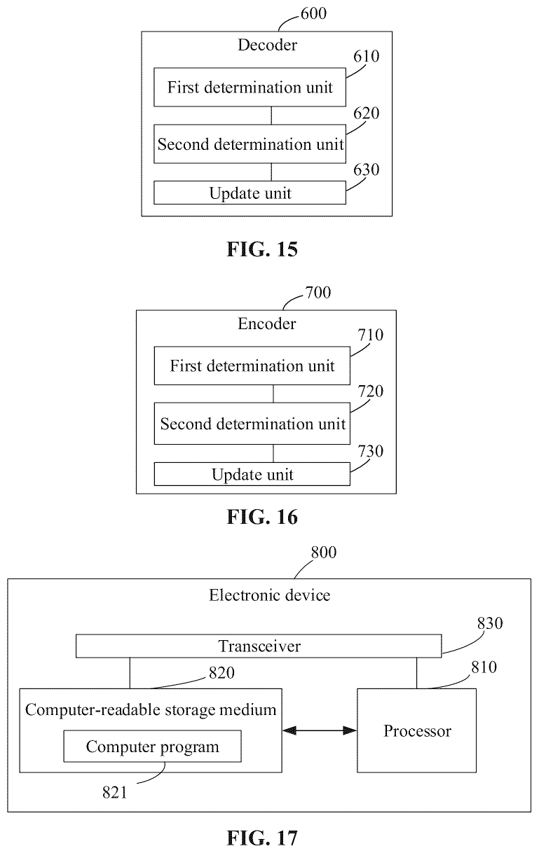

The method embodiments of the disclosure have been described in detail above. The device embodiments of the disclosure are described in detail in conjunction with FIG. 15 to FIG. 17.

FIG. 15 is a schematic block diagram of a decoder 600 according to the disclosure.

As illustrated in FIG. 15, the decoder 600 may include a first determination unit 610, a second determination unit 620, and an update unit 630.

The first determination unit 610 is configured to determine, based on a first prediction mode different from an intra block copy (IBC) mode, block vector information used for a current block.

The second determination unit 620 is configured to determine first historical block vector information based on the block vector information used for the current block.

The update unit 630 is configured to update a first historical block vector information list based on the first historical block vector information.

The first historical block vector information list is used for determining a candidate block vector information list used for IBC blocks, and the IBC blocks are blocks decoded using the IBC mode after the current block.

In some embodiments, the first prediction mode includes an Intra Template Matching Prediction (IntraTMP) mode.

In some embodiments, the second determination unit 620 is specifically configured to:
determine at least one block vector in the first historical block vector information based on at least one block vector in the block vector information used for the current block and the number of the at least one block vector.

In some embodiments, the second determination unit 620 is specifically configured to:
if the number of the at least one block vector is less than or equal to a first preset value, determine the at least one block vector as the block vector(s) in the first historical block vector information.

In some embodiments, the second determination unit 620 is specifically configured to:
if the number of the at least one block vector is greater than a second preset value, determine the block vector(s) in the first historical block vector information according to any one of following:
determining a weighted average of the at least one block vector as a block vector in the first historical block vector information;
determining one or more block vectors having a minimum template error value among the at least one block vector as the at least one block vector in the first historical block vector information; or
determining one or more block vectors, for each of which a reference block has a minimum error value, among the at least one block vector as the at least one block vector in the first historical block vector information.

In some embodiments, the second determination unit 620 is specifically configured to:
if a prediction mode of sub-sample interpolation is used for the current block, determine a first block vector in the block vector information used for the current block as a block vector in the first historical block vector information, or determine a second block vector obtained by adjusting the first block vector based on an adjustment amount of the first block vector, as a block vector in the first historical block vector information.

In some embodiments, the second determination unit 620 is specifically configured to:
if a precision of the first block vector is equal to a precision of the sub-sample interpolation, determine the first block vector as the block vector in the first historical block vector information.

In some embodiments, the second determination unit 620 is specifically configured to:
if a precision of the first block vector is greater than a precision of the sub-sample interpolation, determine the second block vector as the block vector in the first historical block vector information.

In some embodiments, the second determination unit 620 is specifically configured to:
if the first historical block vector information includes a third block vector, determine a precision of one or more block vectors that are in the block vector information used for the current block and are used for determining the third block vector as a precision of the third block vector. The first historical block vector information includes the precision of the third block vector.

In some embodiments, the second determination unit 620 is specifically configured to:
determine, as information in the first historical block vector information, at least one of following in the block vector information used for the current block:
coordinate information of the current block;
an identifier indicating whether to perform illumination compensation on a prediction block for the current block;
an identifier indicating whether to perform filtering on the prediction block for the current block;
an identifier indicating whether to flip a reference block for the current block;
an identifier indicating whether a prediction mode used for the current block is the IBC mode;
an identifier indicating whether the prediction mode used for the current block is the first prediction mode;
an index indicating the prediction mode used for the current block; or
an index indicating weights of multiple reference blocks used for the current block.

In some embodiments, the second determination unit 620 is specifically configured to:
decode a bitstream to determine a first identifier; and
if the first identifier indicates updating the first historical block vector information
list based on the first prediction mode, determine the first historical block vector information based on the block vector information used for the current block.

In some embodiments, the second determination unit 620 is specifically configured to:
if the number of block vectors in the block vector information used for the current block is less than or equal to a third preset value, determine the first historical block vector information based on the block vector information used for the current block.

In some embodiments, the second determination unit 620 is specifically configured to:
determine the first historical block vector information based on the block vector information used for the current block if at least one of following conditions is satisfied:
an area of the current block is greater than or equal to a first threshold;
a width of the current block is greater than or equal to a second threshold;
a height of the current block is greater than or equal to a third threshold; or
a type of a current picture to which the current block belongs is a preset type.

In some embodiments, the update unit 630 is specifically configured to:
if the first historical block vector information list includes the first historical block vector information, move the first historical block vector information to an end of the first historical block vector information list.

In some embodiments, the update unit 630 is specifically configured to:
if the number of pieces of historical block vector information in the first historical block vector information list is less than a fourth preset value, add the first historical block vector information to the first historical block vector information list; otherwise, move out foremost historical block vector information in the first historical block vector information list, and add the first historical block vector information to an end of the first historical block vector information list.

In some embodiments, the first historical block vector information list is a common historical block vector information list for both the first prediction mode and the IBC mode.

In some embodiments, when the first historical block vector information list is used for determining the candidate block vector information list, a priority of second historical block vector information that is in the first historical block vector information list and belongs to the first prediction mode is lower than a priority of third historical block vector information that is in the first historical block vector information list and belongs to the IBC mode.

In some embodiments, the first historical block vector information list is a historical block vector information list for the first prediction mode, and both the first historical block vector information and a second historical block vector information list for the IBC mode are used to determine the candidate block vector information list.

In some embodiments, a priority of the first historical block vector information list in determining the candidate block vector information list is lower than a priority of the second historical block vector information list in determining the candidate block vector information list.

In some embodiments, a current picture to which the current block belongs is partitioned into multiple regions. The multiple regions include a region where the current block is located, and the first historical block vector information list is a historical block vector information list corresponding to the region where the current block is located.

It should be understood that device embodiment of the decoder and method embodiment of the decoding method may correspond to each other, and the method embodiments may be referred to for similar description, which will not be described herein again to avoid repetition. Specifically, the decoder 600 illustrated in FIG. 15 may correspond to a corresponding entity in the decoding method 400 according to the embodiments of the disclosure, and the foregoing and other operations and/or functions of units in the decoder 600 are intended for implementing corresponding processes respectively in methods such as the decoding method 400.

FIG. 16 is a schematic block diagram of an encoder 700 according to the disclosure.

As illustrated in FIG. 16, the encoder 700 may include a first determination unit 710, a second determination unit 720, and an update unit 730.

The first determination unit 710 is configured to determine, based on a first prediction mode different from an intra block copy (IBC) mode, block vector information used for a current block.

The second determination unit 720 is configured to determine first historical block vector information based on the block vector information used for the current block.

The update unit 730 is configured to update a first historical block vector information list based on the first historical block vector information.

The first historical block vector information list is used for determining a candidate block vector information list used for IBC blocks, and the IBC blocks are blocks encoded using the IBC mode after the current block.

In some embodiments, the first prediction mode includes an Intra Template Matching Prediction (IntraTMP) mode.

In some embodiments, the second determination unit 720 is specifically configured to: d
determine at least one block vector in the first historical block vector information based on at least one block vector in the block vector information used for the current block and the number of the at least one block vector.

In some embodiments, the second determination unit 720 is specifically configured to:
if the number of the at least one block vector is less than or equal to a first preset value, determine the at least one block vector as the block vector(s) in the first historical block vector information.

In some embodiments, the second determination unit 720 is specifically configured to:
if the number of the at least one block vector is greater than a second preset value, determine the block vector(s) in the first historical block vector information according to any one of following:
determining a weighted average of the at least one block vector as a block vector in the first historical block vector information;
determining one or more block vectors having a minimum template error value among the at least one block vector as the block vector(s) in the first historical block vector information; or
determining one or more block vectors, for each of which a reference block has a minimum error value, among the at least one block vector as the block vector(s) in the first historical block vector information.

In some embodiments, the second determination unit 720 is specifically configured to:
if a prediction mode of sub-sample interpolation is used for the current block, determine a first block vector in the block vector information used for the current block as a block vector in the first historical block vector information, or determine a second block vector obtained by adjusting the first block vector based on an adjustment amount of the first block vector, as a block vector in the first historical block vector information.

In some embodiments, the second determination unit 720 is specifically configured to:
if a precision of the first block vector is equal to a precision of the sub-sample interpolation, determine the first block vector as the block vector in the first historical block vector information.

In some embodiments, the second determination unit 720 is specifically configured to:
if a precision of the first block vector is greater than a precision of the sub-sample interpolation, determine the second block vector as the block vector in the first historical block vector information.

In some embodiments, the second determination unit 720 is specifically configured to:
if the first historical block vector information includes a third block vector, determine a precision of one or more block vectors that are in the block vector information used for the current block and are used for determining the third block vector as a precision of the third block vector. The first historical block vector information includes the precision of the third block vector.

In some embodiments, the second determination unit 720 is specifically configured to:
determine, as information in the first historical block vector information, at least one of following in the block vector information used for the current block:
coordinate information of the current block;
an identifier indicating whether to perform illumination compensation on a prediction block for the current block;
an identifier indicating whether to perform filtering on the prediction block for the current block;
an identifier indicating whether to flip a reference block for the current block;
an identifier indicating whether a prediction mode used for the current block is the IBC mode;
an identifier indicating whether the prediction mode used for the current block is the first prediction mode;
an index indicating the prediction mode used for the current block; or
an index indicating weights of multiple reference blocks used for the current block.

In some embodiments, the encoder further includes an encoding unit.

The encoding unit is configured to encode a first identifier.

The first identifier indicates updating the first historical block vector information list based on the first prediction mode.

In some embodiments, the second determination unit 720 is specifically configured to:
if the number of block vectors in the block vector information used for the current block is less than or equal to a third preset value, determine the first historical block vector information based on the block vector information used for the current block.

In some embodiments, the second determination unit 720 is specifically configured to:
determine the first historical block vector information based on the block vector information used for the current block if at least one of following conditions is satisfied:
an area of the current block is greater than or equal to a first threshold;
a width of the current block is greater than or equal to a second threshold;
a height of the current block is greater than or equal to a third threshold; or
a type of a current picture to which the current block belongs is a preset type.

In some embodiments, the update unit 730 is specifically configured to:
if the first historical block vector information list includes the first historical block vector information, move the first historical block vector information to an end of the first historical block vector information list.

In some embodiments, the update unit 730 is specifically configured to:
if the number of pieces of historical block vector information in the first historical block vector information list is less than a fourth preset value, add the first historical block vector information to the first historical block vector information list; otherwise, move out foremost historical block vector information in the first historical block vector information list, and add the first historical block vector information to an end of the first historical block vector information list.

In some embodiments, the first historical block vector information list is a common historical block vector information list for both the first prediction mode and the IBC mode.

In some embodiments, when the first historical block vector information list is used for determining the candidate block vector information list, a priority of second historical block vector information that is in the first historical block vector information list and belongs to the first prediction mode is lower than a priority of third historical block vector information that is in the first historical block vector information list and belongs to the IBC mode.

In some embodiments, the first historical block vector information list is a historical block vector information list for the first prediction mode, and both the first historical block vector information and a second historical block vector information list for the IBC mode are used to determine the candidate block vector information list.

In some embodiments, a priority of the first historical block vector information list in determining the candidate block vector information list is lower than a priority of the second historical block vector information list in determining the candidate block vector information list.

In some embodiments, a current picture to which the current block belongs is partitioned into multiple regions. The multiple regions include a region where the current block is located, and the first historical block vector information list is a historical block vector information list corresponding to the region where the current block is located.

It should be understood that device embodiment of the encoder and method embodiment of the encoding method may correspond to each other, and the method embodiments may be referred to for similar description, which will not be described herein again to avoid repetition. Specifically, the encoder 700 illustrated in FIG. 16 may correspond to a corresponding entity in the encoding method 500 according to the embodiments of the disclosure, and the foregoing and other operations and/or functions of units in the encoder 700 are intended for implementing corresponding processes respectively in methods such as the method 500 for encoding.

It should also be understood that units in the decoder 600 or the encoder 700 according to the embodiments of the disclosure are divided based on logical functions; and in practical applications, the functions of one unit may be implemented by multiple units, or the functions of multiple units may be implemented by one unit, or even these functions may be implemented by one or more other units. For example, some or all of the decoder 600 or encoder 700 are merged into one or several additional units. For another example, some unit(s) in the decoder 600 or the encoder 700 may be further divided into multiple functionally smaller units, which can realize the same operation without affecting the realization of the technical effects of the embodiments of the disclosure. For another example, the decoder 600 or the encoder 700 may also include other units; and in practical applications, these functions may also be realized with assistance from other units and may be cooperatively implemented by multiple units.

According to another embodiment of the disclosure, by running a computer program (including program codes) capable of performing steps related to the corresponding method on a general-purpose computing device such as a general-purpose computer including processing elements and storage elements such as a central processing unit (CPU), a random access storage medium (RAM), and a read-only storage medium (ROM), the decoder 600 or the encoder 700 according to the embodiments of the disclosure may be constructed and the encoding method and the decoding method according to embodiments of the disclosure can be implemented. The computer program may be recorded on, for example, a computer-readable storage medium, loaded into an electronic device through the computer-readable storage medium and executed therein to implement the corresponding method of the embodiments of the disclosure. In other words, the above-mentioned units may be implemented in hardware form, may be implemented in software-form instructions, or may be implemented in a combination of software and hardware. Specifically, steps in the methods embodiment in the embodiments of the disclosure may be completed by a hardware integrated logic circuit in the processor and/or instructions in form of software, and the steps in the methods disclosed in the embodiments of the disclosure may be directly embodied as being performed and completed by a hardware decoding processor, or being performed and completed by a combination of hardware and software in a decoding processor. Optionally, the software may be located in a mature storage medium in the art such as a random access memory, a flash memory, a read-only memory, a programmable read-only memory, an electrically erasable programmable, or a register. The storage medium is in a memory, and a processor reads information from the memory to implement steps of the above method embodiments in combination with the hardware.

FIG. 17 is a schematic structural diagram of an electronic device 800 according to the disclosure.

As illustrated in FIG. 17, the electronic device 800 includes at least a processor 810 and a computer-readable storage medium 820. The processor 810 and the computer-readable storage medium 820 may be connected via a bus or other means. The computer-readable storage medium 820 is configured to store a computer program 821 including computer instructions, and the processor 810 is configured to execute the computer instructions stored in the computer-readable storage medium 820. The processor 810 is a computing core and a control core of the electronic device 800, and is adapted to implement one or more computer instructions, in particular to load and execute one or more computer instructions to implement corresponding method procedures or corresponding functions.

Exemplarily, the processor 810 may also be referred to as a Central Processing Unit (CPU). The processor 810 may include but is not limited to: a general-purpose processor, a digital signal processor (DSP), an application specific integrated circuit (ASIC), a field programmable gate array (FPGA), or another programmable logical device, a transistor logical device, a discrete hardware component or the like.

Exemplarily, the computer-readable storage medium 820 may be a high-speed random access memory (RAM), or may be a non-volatile memory, such as at least one magnetic disk storage. Optionally, the computer-readable storage medium 820 may also be at least one computer-readable storage medium located remotely from the processor 810. Specifically, the computer-readable storage medium 820 includes, but is not limited to, a volatile memory and/or a non-volatile memory. The non-volatile memory may be a read-only memory (ROM), a programmable ROM (PROM), an erasable PROM (RPROM), an electrically RPROM (EEPROM), or a flash memory. The volatile memory may be a random access memory (RAM), which serves as an external cache. By way of example, but not limiting description, RAMs in many forms are available, for example, a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a directly rambus RAM (DR RAM).

Exemplarily, the electronic device 800 may be a decoder or a decoding framework according to embodiments of the disclosure. The computer-readable storage medium 820 has second computer instructions stored therein. The processor 810 loads and executes the second computer instructions stored in the computer-readable storage medium 820 to implement corresponding steps in the decoding method according to the disclosure. In other words, the second computer instructions in the computer-readable storage medium 820 are loaded by the processor 810 to perform corresponding steps, which are not described herein in order to avoid repetition.

Exemplarily, the electronic device 800 may be an encoder or encoding framework involved in embodiments of the disclosure. The computer-readable storage medium 820 has first computer instructions stored therein. A processor 810 loads and executes the first computer instructions stored in the computer-readable storage medium 820 to implement corresponding steps in the encoding method according to the disclosure. In other words, the first computer instructions in the computer-readable storage medium 820 are loaded by the processor 810 to perform corresponding steps, which are not described herein in order to avoid repetition.

According to another aspect of the disclosure, a codec system including an encoder and a decoder referred to above is further provided.

According to another aspect of the disclosure, a computer-readable storage medium (memory) is further provided. The computer-readable storage medium is a memory device in the electronic device 800 for storing programs and data, for example, the computer-readable storage medium 820. It is to be understood that the computer-readable storage medium 820 herein may include both a built-in storage medium in the electronic device 800 and, of course, an extended storage medium supported by the electronic device 800. The computer-readable storage medium provides a storage space that stores an operating system of the electronic device 800. Moreover, one or more computer instructions adapted to be loaded and executed by the processor 810 are also stored in the storage space, and the computer instructions may be one or more computer programs 821 (including program codes).

According to another aspect of the disclosure, further provided is a computer program product or computer program including computer instructions stored in a computer readable storage medium, for example, the computer program 821. In this case, the electronic device 800 may be a computer, and the processor 810 reads the computer instructions from the computer-readable storage medium 820 and executes the computer instructions such that the computer performs the encoding method or the decoding method involved above and various optional implementations. In other words, when software is used, the embodiments may be implemented in form of a computer program product completely or in part. The computer program product includes one or more computer instructions. The computer program instructions, when loaded and executed by a computer, operate the procedures according to the embodiments of the disclosure completely or in part or implement functions according to the embodiments of the disclosure completely or in part. The computer may be a universal computer, a dedicated computer, a computer network, or other programmable devices. The computer instructions may be stored in a computer-readable storage medium, or may be transmitted from a computer-readable storage medium to another computer-readable storage medium, for example, the computer instructions may be transmitted from a network station, computer, server or data center to another network station, computer, server or data center in a wired (for example, coaxial cable, fiber, digital subscriber line (DSL)) or wireless (for example, infrared, radio, microwaves) way.

According to another aspect of the disclosure, the disclosure further provides a bitstream, and the bitstream may be a bitstream decoded by using the decoding method according to the disclosure or a bitstream generated by using the encoding method according to the disclosure.

Those of ordinary skill in the art may realize that the units and procedure steps of various examples described in combination with the embodiments disclosed herein may be implemented by electronic hardware, or a combination of computer software and electronic hardware. Whether the functions are performed in form of hardware or software form depends on the specific application and design constraint conditions of the technical solution. Professionals may use a different method to realize the described function for each specific application, and such implementation should not be considered beyond the scope of the disclosure

Finally, it should be noted that the above content is merely detailed description of the disclosure, but the scope of protection of the disclosure is not limited thereto. Any modification or replacement that are easily conceivable by those familiar with the related art within the technical range disclosed by the disclosure shall fall within the scope of protection of the disclosure. Therefore, the scope of protection of the disclosure should be subjected to the claimed scope of the claims.

1. A method for decoding, comprising:
determining, based on a first prediction mode different from an intra block copy (IBC) mode, block vector information used for a current block;
determining first historical block vector information based on the block vector information used for the current block; and
updating a first historical block vector information list based on the first historical block vector information;
wherein the first historical block vector information list is used for determining a candidate block vector information list used for IBC blocks, and the IBC blocks are blocks decoded by using the IBC mode after the current block.

2. The method of claim 1, wherein the first prediction mode comprises an intra template matching prediction (IntraTMP) mode.

3. The method of claim 1, wherein determining the first historical block vector information based on the block vector information used for the current block comprises:
determining at least one block vector in the first historical block vector information based on at least one block vector in the block vector information used for the current block and a number of the at least one block vector.

4. The method of claim 3, wherein determining the at least one block vector in the first historical block vector information based on the at least one block vector in the block vector information used for the current block and the number of the at least one block vector comprises:
if the number of the at least one block vector is less than or equal to a first preset value, determining the at least one block vector as the at least one block vector in the first historical block vector information;
if the number of the at least one block vector is greater than a second preset value, determining the at least one block vector in the first historical block vector information according to any one of following:
determining a weighted average of the at least one block vector as the at least one block vector in the first historical block vector information;
determining one or more block vectors having a minimum template error value among the at least one block vector as the at least one block vector in the first historical block vector information; or
determining one or more block vectors, for each of which a reference block has a minimum error value, among the at least one block vector as the at least one block vector in the first historical block vector information.

5. The method of claim 1, wherein determining the first historical block vector information based on the block vector information used for the current block comprises:
if a prediction mode of sub-sample interpolation is used for the current block, determining a first block vector in the block vector information used for the current block as a block vector in the first historical block vector information, or determining a second block vector obtained by adjusting the first block vector based on an adjustment amount of the first block vector, as a block vector in the first historical block vector information.

6. The method of claim 1, wherein determining the first historical block vector information based on the block vector information used for the current block comprises:
determining, as information in the first historical block vector information, at least one of following in the block vector information used for the current block:
coordinate information of the current block;
an identifier indicating whether to perform illumination compensation on a prediction block for the current block;
an identifier indicating whether to perform filtering on the prediction block for the current block;
an identifier indicating whether to flip a reference block for the current block;
an identifier indicating whether a prediction mode used for the current block is the IBC mode;
an identifier indicating whether the prediction mode used for the current block is the first prediction mode;
an index indicating the prediction mode used for the current block; or
an index indicating weights of a plurality of reference blocks used for the current block.

7. The method of claim 1, wherein determining the first historical block vector information based on the block vector information used for the current block comprises:
determining the first historical block vector information based on the block vector information used for the current block if at least one of following conditions is satisfied:
an area of the current block is greater than or equal to a first threshold;
a width of the current block is greater than or equal to a second threshold;
a height of the current block is greater than or equal to a third threshold; or
a type of a current picture to which the current block belongs is a preset type.

8. The method of claim 1, wherein updating the first historical block vector information list based on the first historical block vector information comprises:
if the first historical block vector information list comprises the first historical block vector information, moving the first historical block vector information to an end of the first historical block vector information list.

9. The method of claim 1, wherein updating the first historical block vector information list based on the first historical block vector information comprises:
if a number of pieces of historical block vector information in the first historical block vector information list is less than a fourth preset value, adding the first historical block vector information to the first historical block vector information list; and
if the number of pieces of historical block vector information in the first historical block vector information list is greater than or equal to the fourth preset value, moving out foremost historical block vector information in the first historical block vector information list, and adding the first historical block vector information to an end of the first historical block vector information list.

10. The method of claim 1, wherein a current picture to which the current block belongs is partitioned into a plurality of regions, the plurality of regions comprise a region where the current block is located, and the first historical block vector information list is a historical block vector information list corresponding to the region where the current block is located.

11. A method for encoding, comprising:
determining, based on a first prediction mode different from an intra block copy (IBC) mode, block vector information used for a current block;
determining first historical block vector information based on the block vector information used for the current block; and
updating a first historical block vector information list based on the first historical block vector information;
wherein the first historical block vector information list is used for determining a candidate block vector information list used for IBC blocks, and the IBC blocks are blocks encoded by using the IBC mode after the current block.

12. The method of claim 11, wherein the first prediction mode comprises an intra template matching prediction (IntraTMP) mode.

13. The method of claim 11, wherein determining the first historical block vector information based on the block vector information used for the current block comprises:
determining at least one block vector in the first historical block vector information based on at least one block vector in the block vector information used for the current block and a number of the at least one block vector.

14. The method of claim 11, wherein determining the first historical block vector information based on the block vector information used for the current block comprises:
if a prediction mode of sub-sample interpolation is used for the current block, determining a first block vector in the block vector information used for the current block as a block vector in the first historical block vector information, or determining a second block vector obtained by adjusting the first block vector based on an adjustment amount of the first block vector, as a block vector in the first historical block vector information.

15. The method of claim 11, wherein determining the first historical block vector information based on the block vector information used for the current block comprises:
determining, as information in the first historical block vector information, at least one of following in the block vector information used for the current block:
coordinate information of the current block;
an identifier indicating whether to perform illumination compensation on a prediction block for the current block;
an identifier indicating whether to perform filtering on the prediction block for the current block;
an identifier indicating whether to flip a reference block for the current block;
an identifier indicating whether a prediction mode used for the current block is the IBC mode;
an identifier indicating whether the prediction mode used for the current block is the first prediction mode;
an index indicating the prediction mode used for the current block; or
an index indicating weights of a plurality of reference blocks used for the current block.

16. The method of claim 11, wherein determining the first historical block vector information based on the block vector information used for the current block comprises:
determining the first historical block vector information based on the block vector information used for the current block if at least one of following conditions is satisfied:
an area of the current block is greater than or equal to a first threshold;
a width of the current block is greater than or equal to a second threshold;
a height of the current block is greater than or equal to a third threshold; or
a type of a current picture to which the current block belongs is a preset type.

17. The method of claim 11, wherein updating the first historical block vector information list based on the first historical block vector information comprises:
if the first historical block vector information list comprises the first historical block vector information, moving the first historical block vector information to an end of the first historical block vector information list.

18. The method of claim 11, wherein updating the first historical block vector information list based on the first historical block vector information comprises:
if a number of pieces of historical block vector information in the first historical block vector information list is less than a fourth preset value, adding the first historical block vector information to the first historical block vector information list; and
if the number of pieces of historical block vector information in the first historical block vector information list is greater than or equal to the fourth preset value, moving out foremost historical block vector information in the first historical block vector information list, and adding the first historical block vector information to an end of the first historical block vector information list.

19. The method of claim 11, wherein a current picture to which the current block belongs is partitioned into a plurality of regions, the plurality of regions comprise a region where the current block is located, and the first historical block vector information list is a historical block vector information list corresponding to the region where the current block is located.

20. A non-transitory computer-readable storage medium having a computer program and a bitstream stored thereon, wherein the computer program that, when executed on a computer, enables the computer to implement the encoding method to generate the bitstream;
wherein the encoding method comprises
determining, based on a first prediction mode different from an intra block copy (IBC) mode, block vector information used for a current block;
determining first historical block vector information based on the block vector information used for the current block; and
updating a first historical block vector information list based on the first historical block vector information;
wherein the first historical block vector information list is used for determining a candidate block vector information list used for IBC blocks, and the IBC blocks are blocks encoded by using the IBC mode after the current block.
